(19) United States
(12) Patent Application Publication
(10) Pub. No.: US 2010/0058054 A1
(43) Pub. Date: Mar. 4, 2010

(54) MSSAN

(76) Inventor: David IRVINE, Ayrshire (GB)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/476,162

(22) Filed: Jun. 1, 2009

Related U.S. Application Data
(63) Continuation of application No. PCT/GB07/04431, filed on Nov. 21, 2007.

(30) Foreign Application Priority Data
Dec. 1, 2006 (GB) 0624056.8
May 22, 2007 (GB) 0709751.2

(51) Int. Cl. H04L 29/06; G06F 21/00

(52) U.S. Cl. 713/165; 726/3; 726/28

(57) ABSTRACT

This invention allows users to maximise their use of existing storage, processing power and network bandwidth resources. This is achieved through providing an enhanced level of data backup and restore that employs the initial encryption of data and storing one user's data on another user's hard drives through an anonymsing process. The efficiency of this process is enhanced when this invention is used in conjunction with self authentication which then provides the ability to log into a network anonymously from potentially anywhere.

### CROSS REFERENCE TO RELATED APPLICATIONS

This application is a continuation of International Application PCT/GB2007/004431 with an International Filing Date of Nov. 21, 2007, and claiming priority to co-pending Great Britain Patent Application No. 0624056.8 filed on Dec. 1, 2006 and co-pending Great Britain Patent Application No. 0709751.2 filed on May 22, 2007, all of which are relied on and incorporated herein by reference.

### STATEMENT OF INVENTION

An issue with today's corporate data networks is that they create many ‘information targets’ for unauthorised persons to focus on. These targets can be centralised servers and centralised account management systems, where these ‘systems’ typically require that authenticated access for IT administration staff is required. It is often the case however that these systems are easily compromised through methods including the increasing use of ‘social engineering’. These vulnerabilities are inherent to today's data management systems and highlight the ultimate importance of maintaining the secrecy of all access to private information and confidential dealings within a corporation.

Another issue is the recovery of data, whether from single machine failures or human error to full blown disaster recovery systems. These systems are well known to cause issues, where even those companies considered to be making substantial investment in IT security systems fail to achieve their goals. An example is to look at the aftermath of 9-11 in the USA, where despite so-called ‘professional strength’ systems being in place, many companies lost data and a fortune was spent attempting to recover hard drives from individual PCs.

This current invention alleviates these issues by first introducing an access system which is granular. This allows upper levels of management or their appointees to sanction and manage access by their direct staff, and so on down the chain (or across in a matrix management situation), to information directly related to single or multiple departments or functions. This invention obfuscates and distributes corporate data either across the Internet as a whole, or within defined corporate networks. This allows massive or total system loss to NOT effect the ability to restore data at any time.

### BACKGROUND OF THE INVENTION

Digital data is today shared amongst trusted users via centralised file or authentication servers. This allows a single point of failure and may possibly open the system to attack as these servers present a target. Storage and authentication today require a great deal of administration, security analysis and time, it is also very likely most systems today can be fully accessed by a system administrator which in itself is a security weakness.

Storage on distributed systems such as the internet is also possible but requires specific storage servers to be available. In addition to these physical systems, data management elements such as security, repair, encryption, authentication, anonymity and mapping etc. are required to ensure successful data transactions and management via the Internet. Listed below is some prior art for these individual elements:

U.S. Pat. No. 6,859,812 discloses a system and method for differentiating private and shared files, where clustered computers share a common storage resource, Network-Attached Storage (NAS) and Storage Area Network (SAN), therefore not distributed as in this present invention. U.S. Pat. No. 5,313,646 has a system which provides a copy-on-write feature which protects the integrity of the shared files by automatically copying a shared file into user's private layer when the user attempts to modify a shared file in a back layer, this is a different technology again and relies on user knowledge—not anonymous. WO02095545 discloses a system using a server for private file sharing which is not anonymous.

A computer system having plural nodes interconnected by a common broadcast bus is disclosed by U.S. Pat. No. 5,117,350. U.S. Pat. No. 5,423,034 shows how each file and level in the directory structure has network access privileges. The file directory structure generator and retrieval tool have a document locator module that maps the directory structure of the files stored in the memory to a real world hierarchical file structure of files. Therefore not distributed across public networks or anonymous or self encrypting, the present inventions does not use broadcasting in this manner.

Authentication servers are for user and data transaction authentication e.g. JP2005311545 which describe a system wherein the application of ‘a digital seal¹ to electronic documents conforms to the Electronic Signature Act. This is similar to the case of signing paper documents but uses the application of an electronic signature through an electronic seal authentication system. The system includes: client computers, to each of which a graphics tablet is connected; an electronic seal authentication server and a PKI authentication server, plus the electronic seal authentication server. US2004254894 discloses an automated system for the confirmed efficient authentication of an anonymous subscriber's profile data in this case.

JP2005339247 describes a server based one time ID system and uses a portable terminal. US2006136317 discloses bank drop down boxes and suggests stronger protection by not transmitting any passwords or IDs. Patent US2006126848 discloses a server centric and deals with a one time password or authentication phrase and is not for use on a distributed network. Patent US2002194484 discloses a distributed network where all chunks are not individually verified and where the manifest is only re-computed after updates to files and hashes are applied and are for validation only.

This is mostly used in biometric (WO2006069158). System for generating a patch file from an old version of data which consists of a series of elements and a new version of data which also consists of a series of elements US2006136514). Authentication servers (therefore not a distributed networking principle as per this invention) are commonly used (JP2006107316, US2005273603, EP1548979). However, server and client exchange valid certificates can be used (US2004255037). Instead of server, uses of information exchange system (semantic information) by participant for authentication can be used (JP2004355358), again this semantic information is stored and referenced unlike this present invention.

Concepts of identity-based cryptography and threshold secret sharing provides for a distributed key management and authentication. Without any assumption of pre-fixed trust relationship between nodes, the ad hoc network works in a self-organizing way to provide the key generation and key management service, which effectively solves the problem of single point of failure in the traditional public key infrastructure (PKI)-supported system (US2006023887). Authenticating involves encryption keys for validation (WO2005055162) these are validated against known users unlike the present invention. Also, for authentication external housing are used (WO2005034009). All of these systems require a lost or (whether distributed or not) record of authorised users and pass phrases or certificates and therefore do not represent prior art.

Ranking, hashing for authentication can be implemented step-by-step and empirical authentication of devices upon digital authentication among a plurality of devices. Each of a plurality of authentication devices can unidirectionally generate a hash value of a low experience rank from a hash value of a high experience rank, and receive a set of high experience rank and hash value in accordance with an experience. In this way, the authentication devices authenticate each other's experience ranks (US2004019788). This is a system of hashing access against known identities and providing a mechanism of effort based access. This present invention does not rely or use such mechanisms.

This is another method for authentication (JP2001308845). Self-verifying certificate for computer system, uses private and public keys—no chunking but for trusted hardware subsystems (US2002080973) this is a mechanism of self signing certificates for authentication, again useful for effort based computing but not used in this present invention. Other authentication modes are, device for exchanging packets of information (JP2001186186), open key certificate management data (JP10285156), and certification for authentication (WO96139210). Authentication for Peer to Peer system is demonstrated by digital rights management (US2003120928). Digital rights management and CSC (part of that patent is a DRM container) issues which are based on ability to use rather than gaining access to network or resources and therefore not prior art.

Known self-healing techniques are divided broadly into two classes. One is a centralized control system that provides overall rerouting control from the central location of a network. In this approach, the rerouting algorithm and the establishing of alarm collection times become increasingly complex as the number of failed channels increases, and a substantial amount of time will be taken to collect alarm signals and to transfer rerouting information should a large number of channels of a multiplexed transmission system fail. The other is a distributed approach in which the rerouting functions are provided by distributed points of the network. The following papers on distributed rerouting approach have been published: (these are all related to self healing but from a network pathway perspective and therefore are not prior art for this invention which deals with data or data chunks self healing mechanisms. Document 1: W. D. Grover, “The Selfhealing Network”, Proceedings of Grobecom '87, November 1987. Document 2: H. C. Yang and S. Hasegawa, “Fitness: Failure Immunization Technology For Network Service Survivability”, Proceedings of Globecom '88, December 1988. Document 3: H. R. Amirazizi, “Controlling Synchronous Networks With Digital Cross-Connect Systems”, Proceedings of Globecom '88, December 1988.

Document 1 is concerned with a restoration technique for failures in a single transmission system, and Document 2 relates to a “multiple-wave” approach in which route-finding packets are broadcast in multiple wave fashion in search of a maximum bandwidth until alternate routes having the necessary bandwidth are established. One shortcoming of this multiple wave approach is that it takes a long recovery time. Document 3 also relates to fault recovery for single transmission systems and has a disadvantage in that route-finding packets tend to form a loop and hence a delay is likely to be encountered.

Most perpetual data generation is allocated with time & calendar etc. (US62669563, JP2001100633). This is not related to this current invention as we have no relation to calendaring, which demonstrates perpetual generation time related data. However, External devices as communication terminal (JP2005057392) (this is a hardware device not related to this present invention) have been used for plurality of packet switching to allow perpetual hand-ff of roaming data between networks and battery pack (EP0944232) has been used to around-the-clock accessibility of customer premises equipment interconnected to a broadband network is enhanced by perpetual mode operation of a broadband network interface. In addition, perpetual data storage and retrieval in reliable manner in peer to peer or distributed network The only link here is these devices are connected to Internet connections but otherwise presents no prior art.

Patents WO9637837, TW223167B, U.S. Pat. No. 6,760,756 and U.S. Pat. No. 7,099,898 describe methods of data replication and retention of data during failure. Patent WO200505060625 discloses method of secure interconnection when failure occurs.

Today systems secure transactions through encryption technologies such as Secure Sockets Layer (SSL), Digital Certificates, and Public Key Encryption technologies. The systems today address the hackers through technologies such as Firewalls and Intrusion Detection systems. The merchant certification programs are designed to ensure the merchant has adequate inbuilt security to reasonably assure the consumer their transaction will be secure. These systems also ensure that the vendor will not incur a charge back by attempting to verify the consumer through secondary validation systems such as password protection and eventually, Smart Card technology.

Network firewalls are typically based on packet filtering which is limited in principle, since the rules that judge which packets to accept or reject are based on subjective decisions. Even VPNs (Virtual Private Networks) and other forms of data encryption, including digital signatures, are not really safe because the information can be stolen before the encryption process, as default programs are allowed to do whatever they like to other programs or to their data files or to critical files of the operating system. This is done by (CA247150) automatically creating an unlimited number of Virtual Environments (VEs) with virtual sharing of resources, so that the programs in each VE think that they are alone on the computer. The present invention takes a totally different approach to security and obviates the requirement of much of the above particularly CA2471505.

U.S. Pat. No. 6,185,316 discloses security via fingerprint imaging testing bit of code using close false images to deter fraudulent copying, this is different from the present invention in that we store no images at all and certainly not in a database.

There are currently several types of centralised file storage systems that are used in business environments. One such system is a server-tethered storage system that communicates with the end users over a local area network, or LAN. The end users send requests for the storage and retrieval of files over the LAN to a file server, which responds by controlling the storage and/or retrieval operations to provide or store the requested files. While such a system works well for smaller networks, there is a potential bottleneck at the interface between the LAN and the file storage system.

Another type of centralised storage system is a storage area network, which is a shared, dedicated high-speed network for connecting storage resources to the servers. While the storage area networks are generally more flexible and scalable in terms of providing end user connectivity to different server-storage environments, the systems are also more complex. The systems require hardware, such as gateways, routers, switches, and are thus costly in terms of hardware and associated software acquisition.

Yet another type of storage system is a network attached storage system in which one or more special-purpose servers handle file storage over the LAN.

Another file storage system utilizes distributed storage resources resident on various nodes, or computers, operating on the system, rather than a dedicated centralised storage system. These are distributed systems, with the clients communicating peer-to-peer to determine which storage resources to allocate to particular files, directories and so forth. These systems are organized as global file stores that are physically distributed over the computers on the system. A global file store is a monolithic file system that is indexed over the system as, for example, a hierarchical directory. The nodes in the systems use Byzantine agreements to manage file replications, which are used to promote file availability and/or reliability. The Byzantine agreements require rather lengthy exchanges of messages and thus are inefficient and even impractical for use in a system in which many modifications to files are anticipated. US200211434 shows a peer-to-peer storage system which describes a storage coordinator that centrally manages distributed storage resources. The difference here is the requirement of a storage broker, making this not fully distributed. The present invention also differs in that the present invention has no central resources for any of the system and we also encrypt data for security as well as the self healing aspect of our system which is again distributed.

U.S. Pat. No. 7,010,532 discloses improved access to information stored on a storage device. A plurality of first nodes and a second node are coupled to one another over a communications pathway, the second node being coupled to the storage device for determining meta data including block address maps to file data in the storage device.

JP2003273860 discloses a method of enhancing the security level during access of an encrypted document including encrypted content. A document access key for decrypting an encrypted content within an encrypted document is stored in a management device, and a user device wishing to access the encrypted document transmits its user ID and a document identification key for the encrypted document, which are encrypted by a private key, together with a public key to the management device to request transmission of the document access key. Differing from this invention in that it never transmit user id or login in the network at all. Also it does not require management devices of any form.

JP2002185444 discloses improves security in networks and the certainty for satisfying processing requests. In the case of user registration, a print server forms a secret key and a public key, and delivers the public key to a user terminal, which forms a user ID, a secret key and a public key, encrypts the user ID and the public key by using the public key, and delivers them to the print server. This is not linked at all to this invention and is a system for a PKI infrastructure for certificate access to network nodes.

The private and public keys of users are used in U.S. Pat. No. 6,925,182, and are encrypted with a symmetric algorithm by using individual user identifying keys and are stored on a network server making it a different proposition from a distributed network

US2005091234 describes data chunking system which divides data into predominantly fixed-sized chunks such that duplicate data may be identified. This is associated with storing and transmitting data for distributed network. US2006206547 discloses a centralised storage system, whilst US2005004947 discloses a new PC based file system. US2005256881 discloses data storage in a place defined by a path algorithm. This is a server based duplicate removal and not necessarily encrypting data, unlike the present invention which does both and requires no servers.

Common email communications of sensitive information is in plain text and is subject to being read by unauthorized code on the senders system, during transit and by unauthorized code on the receiver's system. Where there is a high degree of confidentially required, a combination of hardware and software secures data.

A high degree of security to a computer or several computers connected to the Internet or a LAN as disclosed in US2002099666. Hardware system is used which consists of a processor module, a redundant non-volatile memory system, such as dual disk drives, and multiple communications interfaces. This type of security system must be unlocked by a pass phrase to access data, and all data is transparently encrypted, stored, archived and available for encrypted backup. A system for maintaining secure communications, file transfer and document signing with PKI, and a system for intrusion monitoring and system integrity checks are provided, logged and selectively alarmed in a tamper-proof, time-certain manner.

### SUMMARY OF THE INVENTION

A system of sharing access to private files which has the functional elements of:

1. Perpetual Data

2. Self encryption

3. Data Maps

4. Anonymous Authentication

5. Shared access to Private files

6. ms Messenger
. . . with the additionally linked functional elements of:

1. Peer Ranking

2. Self Healing

3. Security Availability

4. Storage and Retrieval

5. Duplicate Removal

6. Storing Files

7. Chunking

8. Encryption/Decryption

9. Identify Chunks

10. Revision Control

11. Identify Data with Very Small File

12. Logon

13. Provide Key Pairs

14. Validation

15. Create Map of Maps

16. Share Map

17. Provide Public ID

18. Encrypted Communications

19. Document Signing

20. Contract Conversations

A system with simple granular accessibility to data in distributed network or corporate network

A product with simple granular accessibility to data in distributed network or corporate network

A system with simple granular accessibility to data in distributed network or corporate network which is made of inter linkage all or some of the following elements:
a. perpetual data
b. self-encryption
c. data maps
d. anonymous authentication
e. shared access to private files
f. ms messenger

A product with simple granular accessibility to data in distributed network or corporate network which is made of inter linkage all or some of the following elements and sub-elements:
a. perpetual data
b. self-encryption
c. data maps
d. anonymous authentication
e. shared access to private files
f. ms messenger

A system with simple granular accessibility to data in distributed network or corporate network which is made of inter linkage all or some of the following elements and sub-elements:
a. perpetual data
   i. storage and retrieval
   ii. self-healing
   iii. security availability
   iv. peer ranking
b. self-encryption
   ii. encryption/decryption
      key pair
      security
   ii. chunking
      identify chunking
   iii. duplicate removal
      identify chunking
         storage & retrieval
         self healing
   iv. storing files
      identify chunking
      storage & retrieval
      self healing
c. data maps
   i. identify data with small files
      create map of maps
   ii. revision control
      storage and retrieval
   iii. identify chunks
      storing files
      chunking
      duplicate removal
d. anonymous authentication
   i. Validation
      anonymity
      anonymous transaction
      peer ranking
   ii. Provision of Key Pairs
      provision of public ID
      document signing
      encryption/decryption
   iii. Logon
e. shared access to private files
   i. provision of public ID
      share maps
   ii. encrypted communication
      share maps
   iii. identify data with very small file
      create map of maps
f. ms messenger
   i. contract conversations
   ii. document signing
      provision of key pairs
   iii. encrypted communication
      share maps
   iv. provision of public ID
      provision of key pairs
      proven individuals
      interface with anonymous system

A product for a simple granular accessibility to data in distributed network or corporate network which is made of inter linkage all or some of the following elements and sub-elements:
a. perpetual data
   i. storage and retrieval
   ii. self-healing
   iii. security availability
   iv. peer ranking
b. self-encryption
   i. encryption/decryption
      key pair
      security
   ii. chunking
      identify chunking
   iii. duplicate removal
      identify chunking
      storage & retrieval
      self healing
   iv. storing files
      identify chunking
      storage & retrieval
      self healing
c. data maps
   i. identify data with small files
      create map of maps
   ii. revision control
      storage and retrieval
   iii. identify chunks
      storing files
      chunking
      duplicate removal
d. anonymous authentication
   i. Validation
      anonymity
      anonymous transaction
      peer ranking
   ii. Provision of Key Pairs
      provision of public ID
      document signing
      encryption/decryption
   iii. Logon
e. shared access to private files
   i. provision of public ID
      share maps
   ii. encrypted communication
      share maps
   iii. identify data with very small file
      create map of maps
f. ms messenger
   i. contract conversations
   ii. document signing
      provision of key pairs
   iii. encrypted communication
      share maps
   iv. provision of public ID
      provision of key pairs
      proven individuals
      interface with anonymous system

A method of above system and product with simple accessibility to data in distributed network or corporate network

A method of above where granular system access to all data is created, comprising of the following steps;
a. Users log in with a created base ID;
b. The ID is validated from a supervising node (this is a manager);
c. Users provided a further key (manager's key) to allow access by manager.

A method of above where the corporate structure decided upon can be viewed as a tree and accessed as such, to provide access to all users' data beneath or equivalent in some cases to the current user level.

A method of providing file sharing via the implementation of the shared access to private files invention.

A method where all or some copies of data can be stored on the Internet to allow users access from any internet location, removing the requirement for VPN.

A method of providing contract conversations and an encrypted irrefutable messaging system.

A method of implementing a one time ID authentication process to ensure the safety of users and the obfuscation of particular user files and data, thereby dramatically enhancing security.

A method of implementing granular security levels comprising the following options;

a. All data merely backed up and local copy untouched;

b. All data backed up and local copy of chunks maintained (off line mode);

c. All data removed from computer and only accessible from msSAN.

A method where the supervisor or maid ID can be replicated in an shared mechanism such as n+p key sharing, allowing a key to be split across many parties but require only a percentage to retrieve the main key.

### BRIEF DESCRIPTION OF THE SEVERAL VIEWS OF THE DRAWINGS

Embodiments of the present invention will now be described, by way of example only, with reference to the accompanying drawings in which:

FIG. 1a is a system diagram according to the invention;

FIG. 1b is a diagram of perpetual data elements of the system of FIG. 1a;

FIG. 1c is a diagram of self encryption elements of the system of FIG. 1a;

FIG. 1d is a diagram of datamap elements of the system of FIG. 1a;

FIG. 1e is a diagram of anonymous authentication elements of the system of FIG. 1a;

FIG. 1f is a diagram of shared access elements of the system of FIG. 1a;

FIG. 1g is a diagram of messenger elements of the system of FIG. 1a;

FIG. 2 is a flow chart of the self authentication process for the system of FIG. 1a;

FIG. 3 is a diagram of peer to peer interaction for the system of FIG. 1a;

FIG. 4 is a flow chart of the authentication process for the system of FIG. 1a;

FIG. 5 is a flow chart of the data assurance event for the system of FIG. 1a;

FIG. 6 is a flow chart of the chunking event for the system of FIG. 1a;

FIG. 7 is an example of chunking performed by the system of FIG. 1a;

FIG. 8 is a flow chart of the self healing event for the system of FIG. 1a;

FIG. 9 is a flow chart of the peer ranking event for the system of FIG. 1a;

FIG. 10 is a flow chart of the duplicate removal event for the system of FIG. 1a;

FIG. 11 is a diagram of a storage area network provided by the system of FIG. 1a;

FIG. 12 is a flow chart for storing perpetual data performed by the system of FIG. 1a;

FIG. 13 is a diagram of a chunk checking process performed by the system of FIG. 1a;

FIG. 14 is a flow chart of the storage of additional chunks for the system of FIG. 1a;

FIG. 15a is a diagram of the self healing process for the system of FIG. 1a;

FIG. 15b is a flow chart of the self healing process for the system of FIG. 1a;

FIG. 16 is a diagram of shared access for the system of FIG. 1a; and

FIG. 17 is a diagram of a messenger application for the system of FIG. 1a;

### DETAILED DESCRIPTION

### References to IDs Used in Descriptions of the System's Functionality

MID—this is the base ID and is mainly used to store and forget files. Each of these operations will require a signed request. Restoring may simply require a request with an ID attached.

PMID—This is the proxy mid which is used to manage the receiving of instructions to the node from any network node such as get/put/forget etc. This is a key pair which is stored on the node—if stolen the key pair can be regenerated simply disabling the thiefs stolen PMID—although there's not much can be done with a PMID key pair.

CID—Chunk Identifier, this is simply the chunkid.KID message on the net.

TMID—This is today's ID a one time ID as opposed to a one time password. This is to further disguise users and also ensure that their MID stays as secret as possible.

MPID—The maidsafe.net public ID. This is the ID to which users can add their own name and actual data if required. This is the ID for messenger, sharing, non anonymous voting and any other method that requires we know the user.

MAID—this is basically the hash of and actual public key of the MID. this ID is used to identify the user actions such as put/forget/get on the maidsafe.net network. This allows a distributed PKI infrastructure to exist and be automatically checked.

KID—Kademlia ID this can be randomly generated or derived from known and preferably anonymous information such as an anonymous public key hash as with the MAID. In this case we use kademlia as the example overlay network although this can be almost any network environment at all.

MSID—maidsafe.net Share ID, an ID and key pair specifically created for each share to allow users to interact with shares using a unique key not related to their MID which should always be anonymous and separate.

### Anonymous Authentication Description

Anonymous authentication relates to system authentication and, in particular, authentication of users for accessing resources stored on a distributed or peer-to-peer file system. Its aim is to preserve the anonymity of the users and to provide secure and private storage of data and shared resources for users on a distributed system. It is a method of authenticating access to a distributed system comprising the steps of;
Receiving a user identifier;
Retrieving an encrypted validation record identified by the user identifier;
Decrypting the encrypted validation record so as to provide decrypted information; and . . .
Authenticating access to data in the distributed system using the decrypted information.

Receiving, retrieving and authenticating may be performed on a node in the distributed system preferably separate from a node performing the step of decrypting. The method further comprises the step of generating the user identifier using a hash. Therefore, the user identifier may be considered unique (and altered if a collision occurs) and suitable for identifying unique validation records. The step of authenticating access may preferably further comprise the step of digitally signing the user identifier. This provides authentication that can be validated against trusted authorities. The method further comprises the step of using the signed user identifier as a session passport to authenticate a plurality of accesses to the distributed system. This allows persistence of the authentication for an extended session.

The step of decrypting preferably comprises decrypting an address in the distributed system of a first chunk of data and the step of authenticating access further comprises the step of determining the existence of the first chunk at the address, or providing the location and names of specific data elements in the network in the form of a data map as previously describe. This efficiently combines the tasks of authentication and starting to retrieve the data from the system. The method preferably further comprises the step of using the content of the first chunk to obtain further chunks from the distributed system. Additionally the decrypted data from the additional chunks may contain a key pair allowing the user at that stage to sign a packet sent to the network to validate them or additionally may preferable self sign their own id.

Therefore, there is no need to have a potentially vulnerable record of the file structure persisting in one place on the distributed system, as the user's node constructs its database of file locations after logging onto the system.

There is provided a distributed system comprising;
a storage module adapted to store an encrypted validation record;
a client node comprising a decryption module adapted to decrypt an encrypted validation record so as to provide decrypted information; and
a verifying node comprising:
a receiving module adapted to receive a user identifier;
a retrieving module adapted to retrieve from the storage module an encrypted validation record identified by the user identifier;
a transmitting module adapted to transmit the encrypted validation record to the client node; and
an authentication module adapted to authenticate access to data in the distributed file system using the decrypted information from the client node.

The client node is further adapted to generate the user identifier using a hash. The authentication module is further adapted to authenticate access by digitally sign the user identifier. The signed user identifier is used as a session passport to authenticate a plurality of accesses by the client node to the distributed system. The decryption module is further adapted to decrypt an address in the distributed system of a first chunk of data from the validation record and the authentication module is further adapted to authenticate access by determining the existence of the first chunk at the address. The client node is further adapted to use the content of the first chunk to obtain further authentication chunks from the distributed system.

There is provided at least one computer program comprising program instructions for causing at least one computer to perform. One computer program is embodied on a recording medium or read-only memory, stored in at least one computer memory, or carried on an electrical carrier signal.

Additionally there is a check on the system to ensure the user is login into a valid node (software package). This will preferably include the ability of the system to check validity of the running maidsafe.net software by running content hashing or preferably certificate checking of the node and also the code itself.

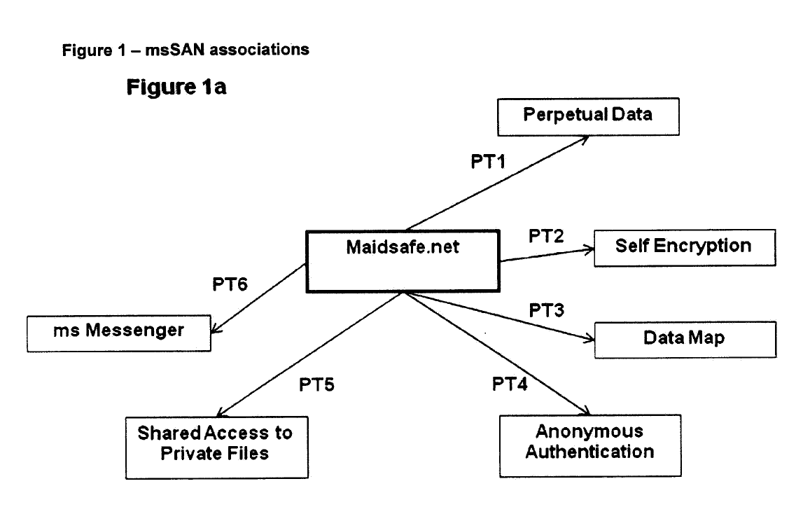

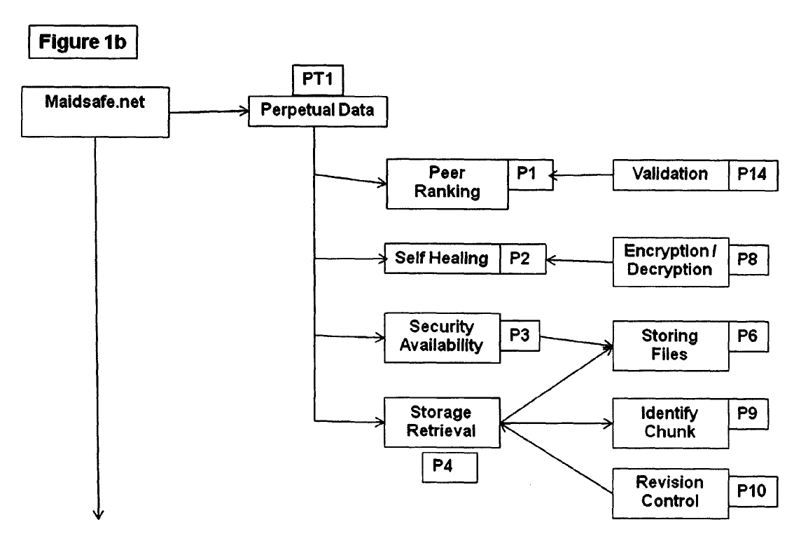

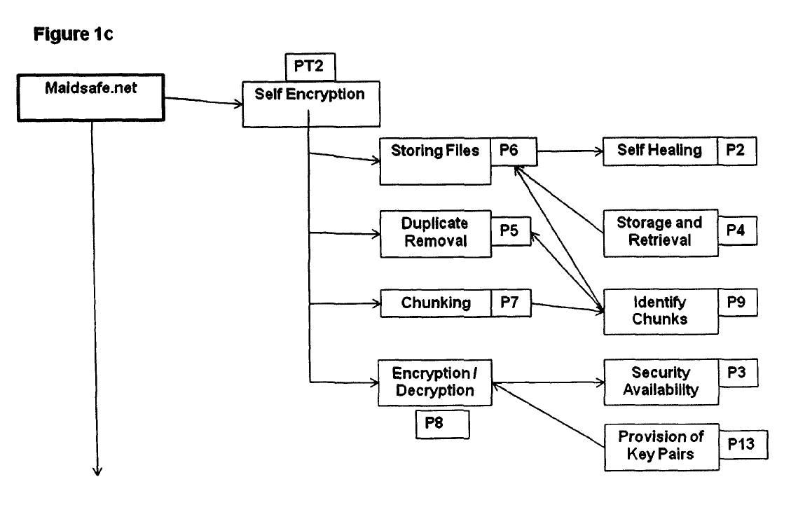

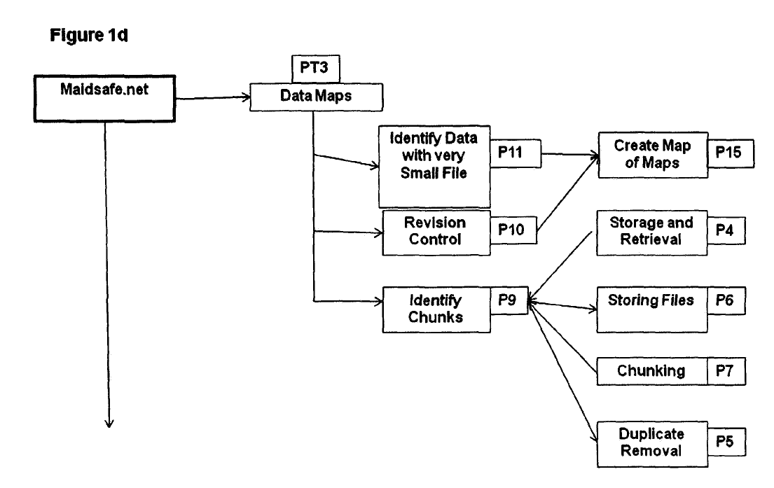

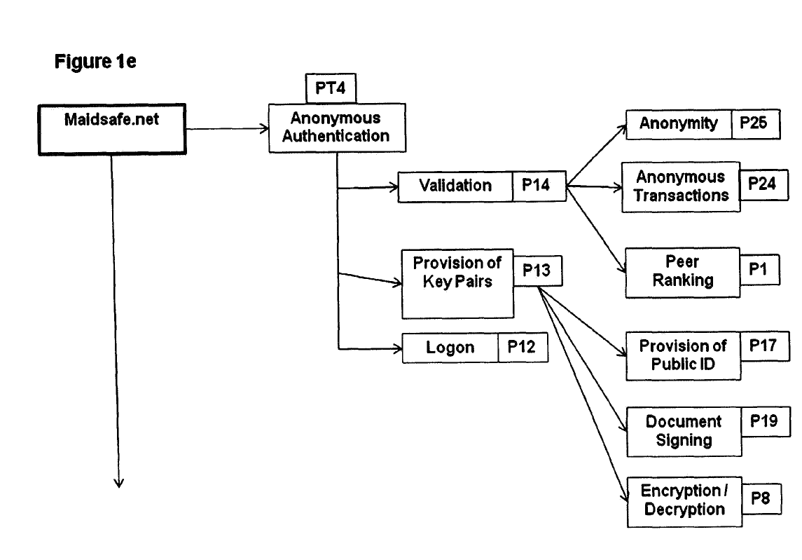

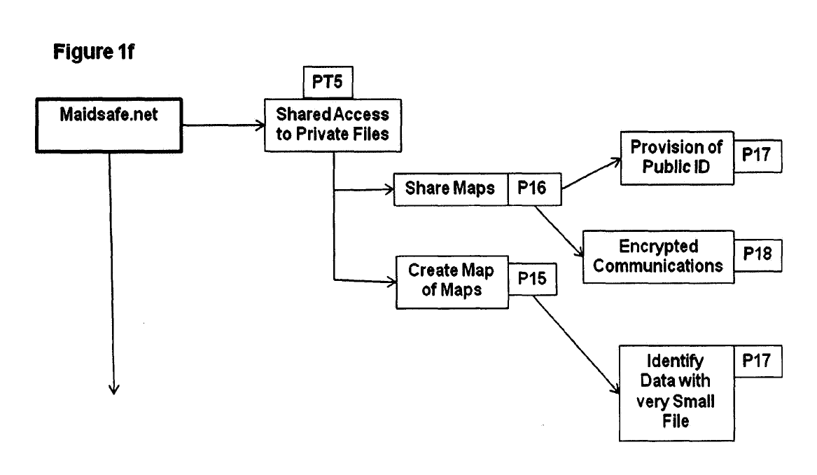

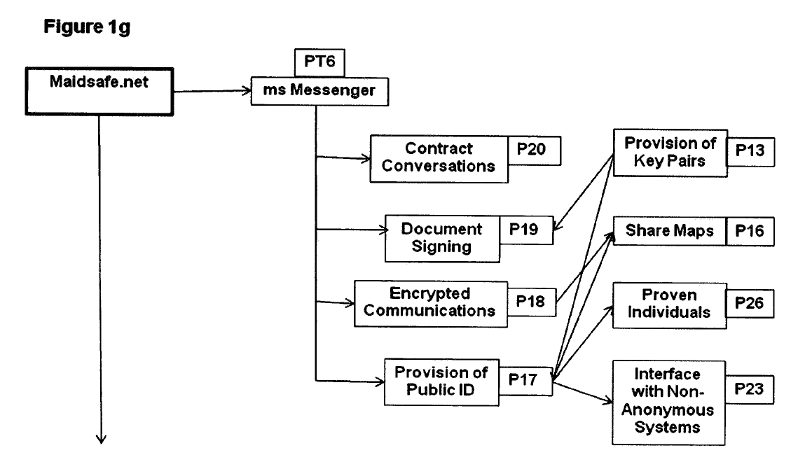

Linked Elements for maidsafe.net (FIG. 1)

The maidsafe.net product invention consists of 6 individual inventions, which collectively have 20 inter-linked functional elements, these are:

The individual inventions are:
PT1—Perpetual Data
PT2—Self encryption
PT3—Data Maps
PT4—Anonymous Authentication
PT5—Shared access to Private files
PT6—ms Messenger

The inter-linked functional elements are:
P1—Peer Ranking
P2—Self Healing
P3—Security Availability
P4—Storage and Retrieval
P5—Duplicate Removal
P6—Storing Files
P7—Chunking
P8—Encryption/Decryption
P9—Identify Chunks
P10—Revision Control
P11—Identify Data with Very Small File
P12—Logon
P13—Provide Key Pairs
P14—Validation
P15—Create Map of Maps
P16—Share Map
P17—Provide Public ID
P18—Encrypted Communications
P19—Document Signing
P20—Contract Conversations

maidsafe is a product and system (maidsafe.net) which works with linkage of numbers of elements which within themselves sub-elements. FIG. 1 illustrates the linkage of novel elements, perpetual data (PT1), self-encryption (PT2), data maps (PT3), anonymous authentication (PT4), shared access to private files (PT5), ms messenger (PT6), cyber cash (PT7) and world-wide voting system (PT8), which allows the maidsafe to exhibit attributes with all these novel elements and provides combined benefits such as anonymous secure communications, store and retrieve data, access data from any internet connected computing device & share resources, anonymous backup and restoring of data, share private, files & secure data without using any authentication server or file server, anonymous authentication of users (without user access lists or user-name password type devices as seen today), approve transaction based on signed serialised and anonymous digital currency and CPU sharing controlled via an anonymous voting system, added to this the anonymous voting system has vote validation and repudiation.

The perpetual data (PT1) itself is preferably made up from linkage of elements, peer ranking (P1), security availability (P2), self-healing (P3) and storage and retrieval (P4) which allows creation of perpetual data within distributed or peer-to-peer network. This allows data to be maintained in a manner which effectively guarantees availability barring a major global disaster. In addition, Peer ranking element (P1) is preferably dependent upon another sub-element validation process (P14) to ensure data copies are both available and intact, security availability element (P2) is preferably dependent upon sub-element encryption/decryption (P8) to ensure data checking whilst remaining secure and anonymous, self-healing element (P3) preferably generates sub-element storing files (P6) which ensures data can be retrieved on hardware or software failure (such as loss of large network portions) and storage and retrieval element (P4) is preferably provided by sub-element revision control (P10) to allow historic data to be recovered and preferably generates sub-elements identify chunks (P9) and storing files (P6) to complete perpetual data.

The self-encryption (PT2) itself is made up from linkage of elements, storing file (P6), duplicate removal (P5), chunking (P7) and encryption/decryption (P8) which allows a self-encryption process to provide security and global duplicate data removal. In addition, storing file element (P6) is preferably dependent upon sub-elements storage and retrieval (P4) and sub-element identify chunks (P9) and generate sub-element self-healing (P2), duplicate removal element (P5) is preferably dependent on sub-element identify chunks (P9), chunking element (P7) generate sub-element identify chunks (P9) and encryption/decryption element (P8) can be provided by sub-element provision of keys (P 13) to ensure validity of generating or requesting nodes anonymous identity (e.g. we don't know who it is but we know it was the node that put the chunk there).

The data maps (PT3) itself is made up from linkage of elements, identify chunks (P9), preferably revision control (P10), and identify data with small files (P11) to provide a data mapping system for data location or naming convention storing or accessing on distributed or peer to peer network. In addition, identify chunks element (P9) is dependent on sub-elements storage and retrieval (P4) and preferably sub-elements chunking (P7) and preferably generate sub-elements duplicate removal (P5) and sub-elements storing files (P6), revision control (P10) generates sub-element storage and retrieval (P4), and preferably identify data with small data elements (P11) generate sub-element create map of maps (P15) to allow private data sharing.

The anonymous authentication (PT4) itself is made up from linkage of elements, logon (P12) preferably provision of key pairs (P13) and validation (P 14), to provide an anonymous authentication system for users requiring to be allowed access to resources stored on a distributed or peer-to-peer system and to preserve the anonymity of the user and to provide a mechanism for secure access to private storage of data and preferably other resources on a distributed file system. In addition, logon provision of key pairs element (P13) provides a sub-element provision of public ID (P17) which allows sub-element document signing (P19), and sub-element encryption/decryption (P8) where required; element validation is dependent on sub-element anonymity (P25) and provides sub-element anonymous transaction (P24) and is provisioned by sub-element peer ranking (P1).

The shared access to private files (PT5) itself is made up from linkage of elements, share maps (P 16) and create map of maps (P 15) to provide a mechanism for secure sharing of data within a secure or insecure network environment and to obviate the need for file servers and replace their function with a distributed network of preferably standard processing or computing nodes. In addition, share maps element (P16)) is preferably dependent on sub-element provision of public ID (P17) and preferably sub-element encrypted communication (P18), and may make use of create map of maps element (P15) which is dependent on sub-element identify data with very small data element (P11).

The ms messenger (PT6) itself is made up from linkage of elements, provision of public ID (P17), preferably encrypted communication (P18) and preferably provides document signing (P19) and contract conversations (P20) to provide a system of messaging where identity is validated to prevent spam. The system further uses this identity and key pair to allow digitally validated document signing. In addition, provision of public ID element (P17) is dependent on sub-element provision of key pairs (P13) and preferably generate sub-element share maps (P26), sub-element proven individual (P26) and sub-element interface with non-anonymous systems (P23). Preferably the encrypted communication element (P18) generates sub-element share maps (P16) and initiates the validation process (P28) and document signing element (P19) is preferably dependent on sub-element provision of key pairs (P13)

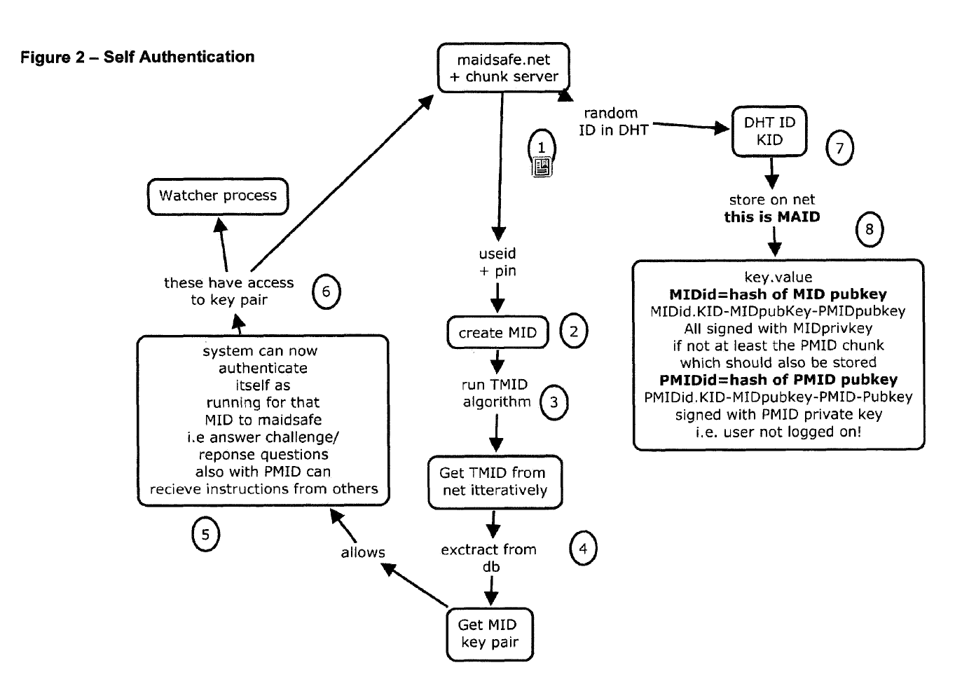

### Self Authentication Detail (FIG. 2)

1. A computer program consisting of a user interface and a chunk server (a system to process anonymous chunks of data) should be running, if not they are started when user selects an icon or other means of starting the program.

2. A user will input some data known to them such as a userid (random ID) and PIN number in this case. These pieces of information may be concatenated together and hashed to create a unique (which may be confirmed via a search) identifier. In this case this is called the MID (maidsafe.net ID)

3. A TMID (Today's MID) is retrieved from the network, the TMID is then calculated as follows:

The TMID is a single use or single day ID that is constantly changed. This allows maidsafe.net to calculate the hash based on the user ID pin and another known variable which is calculable. For this variable we use a day variable for now and this is the number of days since epoch (Jan. 1, 1970). This allows for a new ID daily, which assists in maintaining the anonymity of the user. This TMID will create a temporary key pair to sign the database chunks and accept a challenge response from the holder of these db chunks. After retrieval and generation of a new key pair the db is put again in new locations—rendering everything that was contained in the TMID chunk useless. The TMID CANNOT be signed by anyone (therefore hackers can't BAN an unsigned user from retrieving this—in a DOS attack)—it is a special chunk where the data hash does NOT match the name of the chunk (as the name is a random number calculated by hashing other information (i.e. its a hash of the TMID as described below)
take dave as user ID and 1267 as pin.
dave+(pin) 1267=dave1267 Hash of this becomes MID
day variable (say today is 13416 since epoch)=13416
so take pin, and for example add the number in where the pin states i.e.
613dav41e1267
(6 at beginning is going round pin again)
so this is done by taking 1st pin 1—so put first day value at position 1
then next pin number 2—so day value 2 at position 2
then next pin number 6 so day value 3 at position 6
then next pin number 7 so day value 4 at position 7
then next pin number is 1 so day value 5 at position 1 (again)
so TMID is hash of 613dav41e1267 and the MID is simply a hash of dave1267
(This is an example algorithm and many more can be used to enforce further security.)

4. From the TMID chunk the map of the user's database (or list of files maps) is identified. The database is recovered from the net which includes the data maps for the user and any keys passwords etc. The database chunks are stored in another location immediately and the old chunks forgotten. This can be done now as the MID key pair is also in the database and can now be used to manipulate user's data.

5. The maidsafe.net application can now authenticate itself as acting for this MID and put get or forget data chunks belonging to the user. The watcher process and Chunk server always have access to the PMID key pair as they are stored on the machine itself, so can start and receive and authenticate anonymous put/get/forget commands.

6. A DHT ID is required for a node in a DHT network this may be randomly generated or in fact we can use the hash of the PMID public key to identify the node.

7. When the users successfully logged in he can check his authentication validation records exist on the network. These may be as follows:

MAID (maidsafe.net Anonymous ID)

1. This is a data element stored on net and preferably named with the hash of the MID public Key.

2. It contains the MID public key+any PMID public keys associated with this user.

3. This is digitally signed with the MID private key to prevent forgery.

4. Using this mechanism this allows validation of MID signatures by allowing any users access to this data element and checking the signature of it against any challenge response from any node pertaining to be this MID (as only the MID owner has the private key that signs this MID) Any crook could not create the private key to match to the public key to digitally sign so forgery is made impossible given today's computer resources.

5. This mechanism also allows a user to add or remove PMIDS (or chunk servers acting on their behalf like a proxy) at will and replace PMID's at any time in case of the PMID machine becoming compromised. Therefore this can be seen as the PMID authentication element.

### PMID (Proxy MID)

1. This is a data element stored on the network and preferably named with the hash of the PMID public key.

2. It contains the PMID public key and the MID ID (i.e. the hash of the MID public key) and is signed by the MID private key (authenticated).

3. This allows a machine to act as a repository for anonymous chunks and supply resources to the net for a MID.

4. When answering challenge responses any other machine will confirm the PMID by seeking and checking the MIAD for the PMID and making sure the PMID is mentioned in the MAID bit—otherwise the PMID is considered rouge.

5. The key pair is stored on the machine itself and may be encoded or encrypted against a password that has to be entered upon start-up (optionally) in the case of a proxy provider who wishes to further enhance PMID security.

6. The design allows for recovery from attack and theft of the PMID key pair as the MAID data element can simply remove the PMID ID from the MAID rendering it unauthenticated.

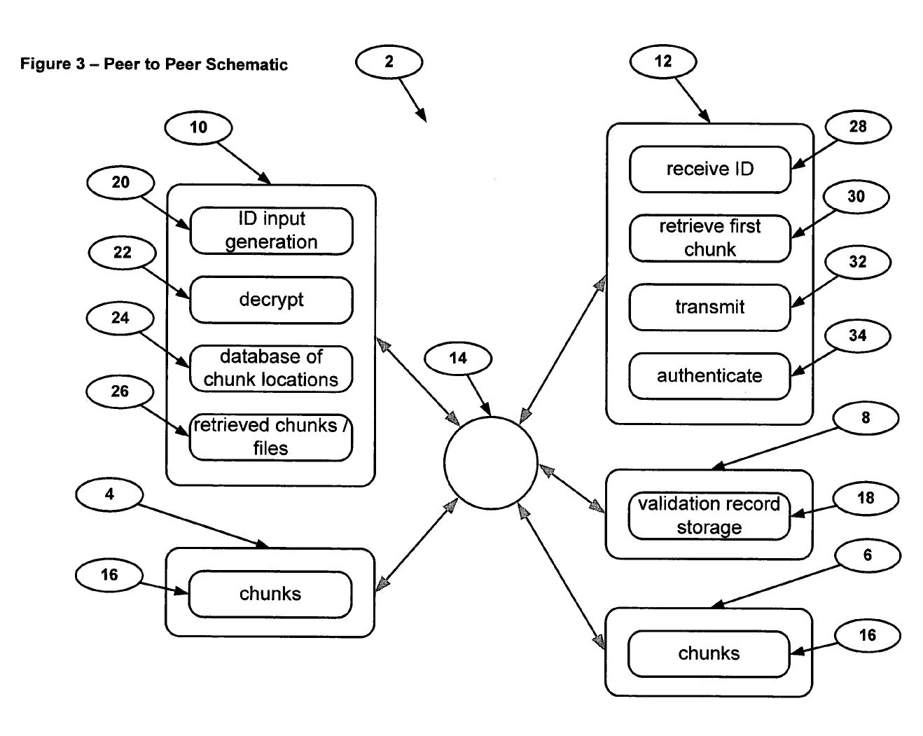

FIG. 3 illustrates, in schematic form, a peer-to-peer network in accordance with an embodiment of the invention; and

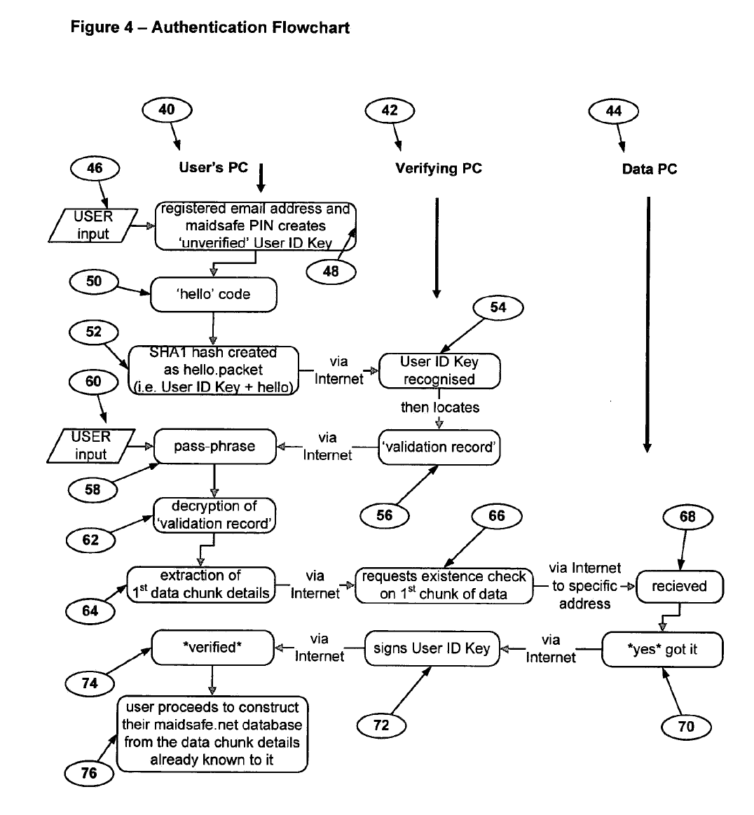

FIG. 4 illustrates a flow chart of the authentication, in accordance with a preferred embodiment of the present invention.

With reference to FIG. 3, a peer-to-peer network 2 is shown with nodes 4 to 12 connected by a communication network 14. The nodes may be Personal Computers (PCs) or any other device that can perform the processing, communication and/or storage operations required to operate the invention. The file system will typically have many more nodes of all types than shown in FIG. 3 and a PC may act as one or many types of node described herein. Data nodes 4 and 6 store chunks 16 of files in the distributed system. The validation record node 8 has a storage module 18 for storing encrypted validation records identified by a user identifier.

The client node 10 has a module 20 for input and generation of user identifiers. It also has a decryption module 22 for decrypting an encrypted validation record so as to provide decrypted information, a database or data map of chunk locations 24 and storage 26 for retrieved chunks and files assembled from the retrieved chunks.

The verifying node 12 has a receiving module 28 for receiving a user identifier from the client node. The retrieving module 30 is configured to retrieve from the data node an encrypted validation record identified by the user identifier. Alternatively, in the preferred embodiment, the validation record node 8 is the same node as the verifying node 12, i.e. the storage module 18 is part of the verifying node 12 (not as shown in FIG. 3). The transmitting module 32 sends the encrypted validation record to the client node. The authentication module 34 authenticates access to chunks of data distributed across the data nodes using the decrypted information.

With reference to FIG. 4, a more detailed flow of the operation of the present invention is shown laid out on the diagram with the steps being performed at the User's PC (client node) on the left 40, those of the verifying PC (node) in the centre 42 and those of the data PC (node) on the right 44.

A login box is presented 46 that requires the user's name or other detail Preferably email address (the same one used in the client node software installation and registration process) or simply name (i.e. nickname) and the user's unique number, preferably PIN number. If the user is a ‘main user’ then some details may already be stored on the PC. If the user is a visitor, then the login box appears.

A content hashed number such as SHA (Secure Hash Algorithm), Preferably 160 bits in length, is created 48 from these two items of data. This ‘hash’ is now known as the ‘User ID Key’ (MID), which at this point is classed as ‘unverified’ within the system. This is stored on the network as the MAID and is simply the hash of the public key containing an unencrypted version of the public key for later validation by any other node. This obviates the requirement for a validation authority

The software on the user's PC then combines this MID with a standard ‘hello’ code element 50, to create 52 a ‘hello.packet’. This hello.packet is then transmitted with a timed validity on the Internet.

The hello.packet will be picked up by the first node (for this description, now called the ‘verifying node’) that recognises 54 the User ID Key element of the hello.packet as matching a stored, encrypted validation record file 56 that it has in its storage area. A login attempt monitoring system ensures a maximum of three responses. Upon to many attempts, the verifying PC creates a ‘black list’ for transmission to peers. Optionally, an alert is returned to the user if a ‘black list’ entry is found and the user may be asked to proceed or perform a virus check.

The verifying node then returns this encrypted validation record file to the user via the internet. The user's pass phrase 58 is requested by a dialog box 60, which then will allow decryption of this validation record file.

When the validation record file is decrypted 62, the first data chunk details, including a ‘decrypted address’, are extracted 64 and the user PC sends back a request 66 to the verifying node for it to initiate a query for the first ‘file-chunk ID¹ at the ‘decrypted address’ that it has extracted from the decrypted validation record file, or preferably the data map of the database chunks to recreate the database and provide access to the key pair associated with this MID.

The verifying node then acts as a ‘relay node’ and initiates a ‘notify only’ query for this ‘file-chunk ID’ at the “decrypted address”.

Given that some other node (for this embodiment, called the ‘data node’) has recognised 68 this request and has sent back a valid ‘notification only’ message 70 that a ‘file-chunk ID’ corresponding to the request sent by the verifying node does indeed exist, the verifying node then digitally signs 72 the initial User ID Key, which is then sent back to the user.

On reception by the user 74, this verified User ID Key is used as the user's session passport. The user's PC proceeds to construct 76 the database of the file system as backed up by the user onto the network. This database describes the location of all chunks that make up the user's file system. Preferably the ID Key will contain irrefutable evidence such as a public/private key pair to allow signing onto the network as authorised users, preferably this is a case of self signing his or her own ID—in which case the ID Key is decrypted and user is valid-self validating.

Further details of the embodiment will now be described. A ‘proxy-controlled’ handshake routine is employed through an encrypted point-to-point channel, to ensure only authorised access by the legal owner to the system, then to the user's file storage database, then to the files therein. The handshaking check is initiated from the PC that a user logs on to (the ‘User PC), by generating the ‘unverified encrypted hash’ known as the ‘User ID Key’, this preferably being created from the user's information preferably email address and their PIN number. This ‘hash’ is transmitted as a ‘hello.packet” on the Internet, to be picked up by any system that recognises the User ID as being associated with specific data that it holds. This PC then becomes the ‘verifying PC and will initially act as the User PCs ‘gateway’ into the system during the authentication process. The encrypted item of data held by the verifying PC will temporarily be used as a ‘validation record’, it being directly associated with the user's identity and holding the specific address of a number of data chunks belonging to the user and which are located elsewhere in the peer-to-peer distributed file system. This ‘validation record’ is returned to the User PC for decryption, with the expectation that only the legal user can supply the specific information that will allow its accurate decryption.

Preferably this data may be a signed response being given back to the validating node which is possible as the id chunk when decrypted (preferably symmetrically) contains the users public and private keys allowing non refutable signing of data packets.

Preferably after successful decryption of the TMID packet (as described above) the machine will now have access to the data map of the database and public/private key pair allowing unfettered access to the system.

It should be noted that in this embodiment, preferably no communication is carried out via any nodes without an encrypted channel such as TLS (Transport Layer Security) or SSL (Secure Sockets Layer) being set up first. A peer talks to another peer via an encrypted channel and the other peer (proxy) requests the information (e.g. for some space to save information on or for the retrieval of a file). An encrypted link is formed between all peers at each end of communications and also through the proxy during the authentication process. This effectively bans snoopers from detecting who is talking to whom and also what is being sent or retrieved. The initial handshake for self authentication is also over an encrypted link.

Secure connection is provided via certificate passing nodes, in a manner that does not require intervention, with each node being validated by another, where any invalid event or data, for whatever reason (fraud detection, snooping from node or any invalid algorithms that catch the node) will invalidate the chain created by the node. This is all transparent to the user.

Further modifications and improvements may be added without departing from the scope of the invention herein described.

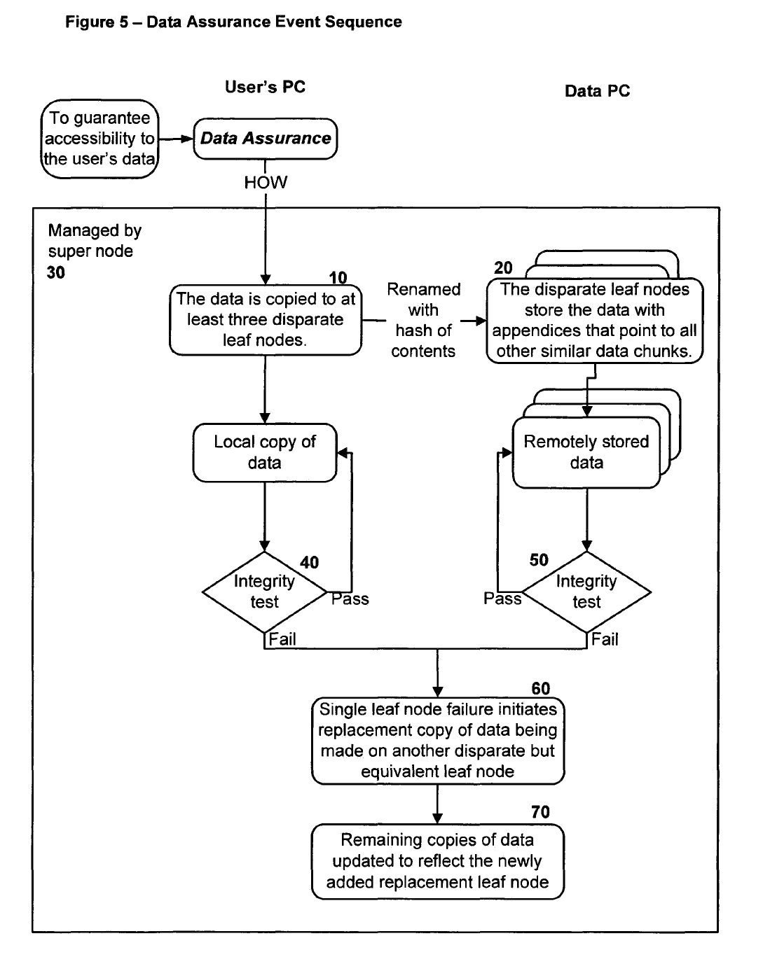

FIG. 5 illustrates a flow chart of data assurance event sequence in accordance with first embodiment of this invention

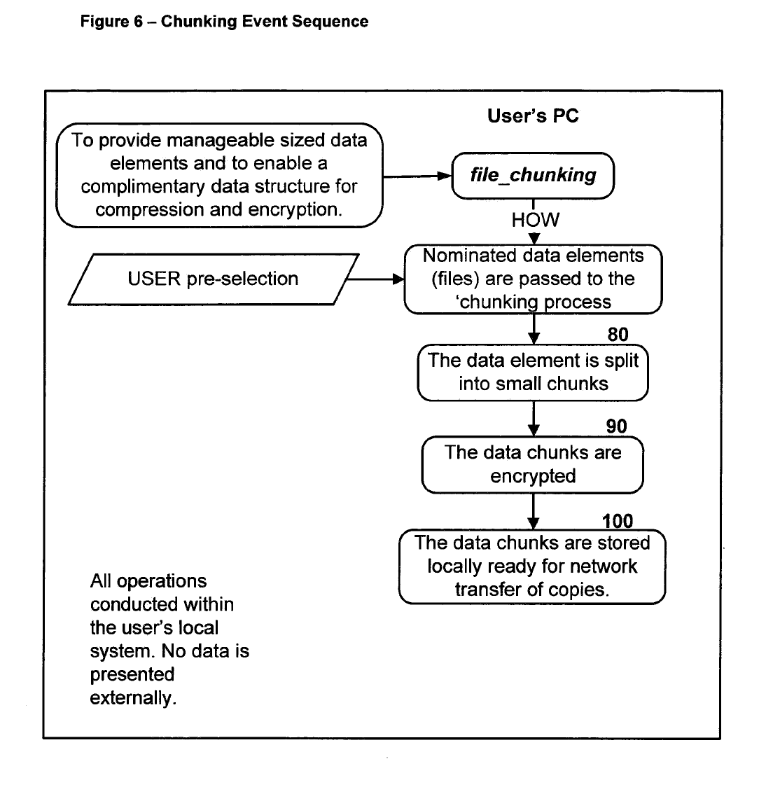

FIG. 6 illustrates a flow chart of file chunking event sequence in accordance with second embodiment of this invention

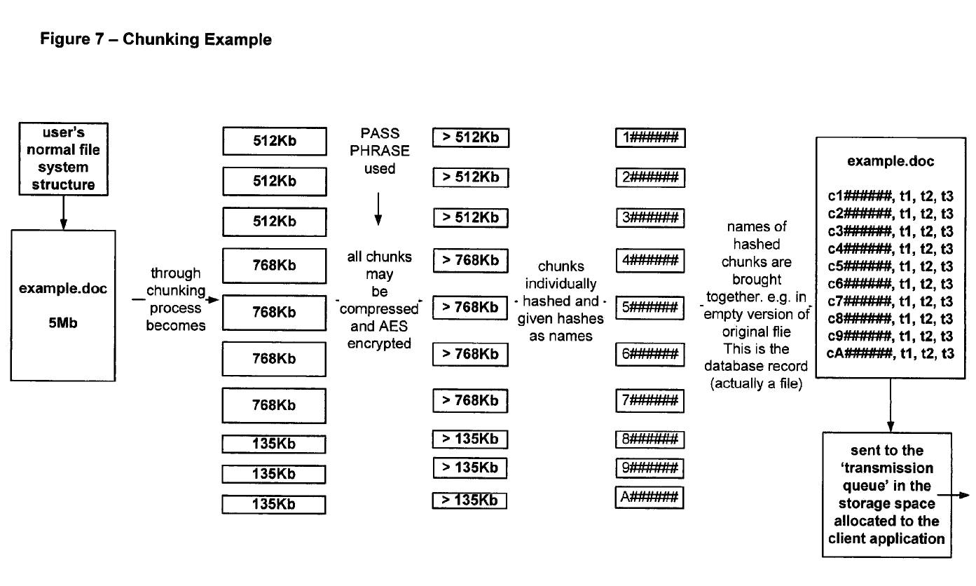

FIG. 7 illustrates a schematic diagram of file chunking example

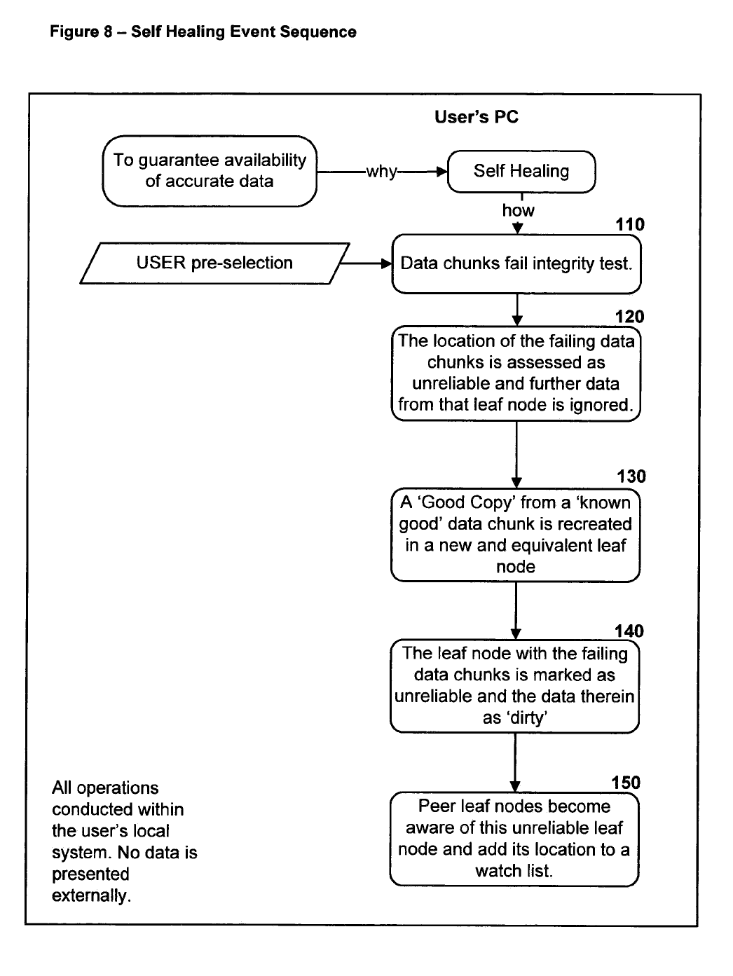

FIG. 8 illustrates a flow chart of self healing event sequence

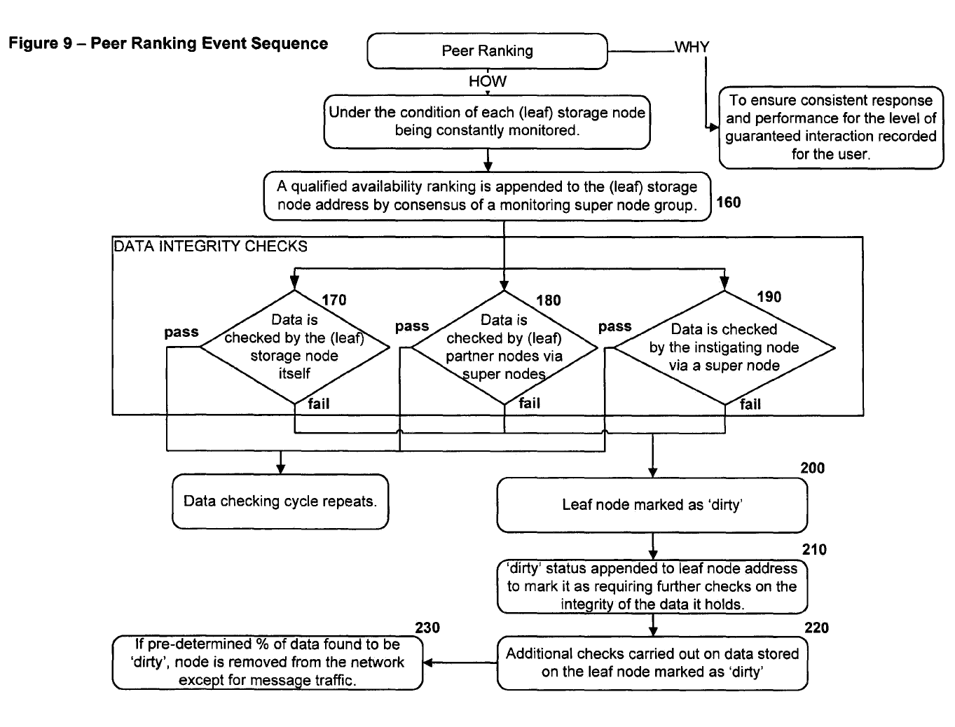

FIG. 9 illustrates a flow chart of peer ranking event sequence

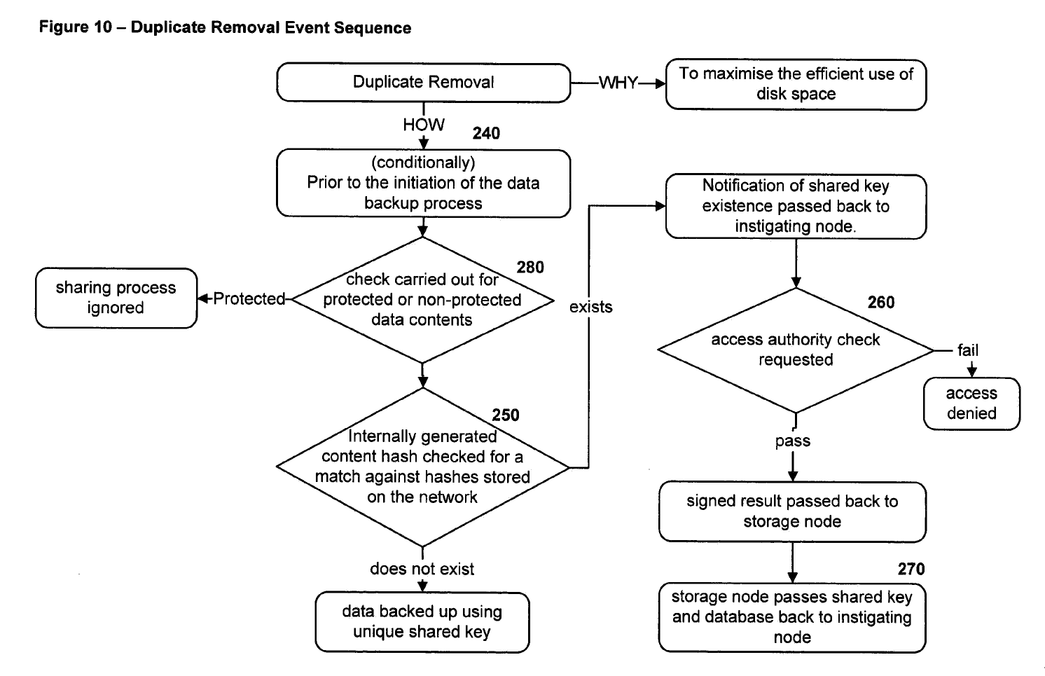

FIG. 10 illustrates a flow chart of duplicate removal event sequence

With reference to FIG. 5, guaranteed accessibility to user data by data assurance is demonstrated by flow chart. The data is copied to at least three disparate locations at step (10). The disparate locations store data with an appendix pointing to the other two locations by step (20) and is renamed with hash of contents. Preferably this action is managed by another node i.e. super node acting as an intermediary by step (30).

Each local copy at user's PC is checked for validity by integrity test by step (40) and in addition validity checks by integrity test are made that the other 2 copies are also still ok by step (50).

Any single node failure initiates a replacement copy of equivalent leaf node being made in another disparate location by step (60) and the other remaining copies are updated to reflect this change to reflect the newly added replacement leaf node by step (70).

The steps of storing and retrieving are carried out via other network nodes to mask the initiator (30).

The method further comprises the step of renaming all files with a hash of their contents.

Therefore, each file can be checked for validity or tampering by running a content hashing algorithm such as (for example) MD5 or an SHA variant, the result of this being compared with the name of the file.

With reference to FIG. 6, provides a methodology to manageable sized data elements and to enable a complimentary data structure for and compression and encryption and the step is to file chunking. By user's pre-selection the nominated data elements (files are passed to chunking process. Each data element (file) is split into small chunks by step (80) and the data chunks are encrypted by step (90) to provide security for the data. The data chunks are stored locally at step (100) ready for network transfer of copies. Only the person or the group, to whom the overall data belongs, will know the location of these (100) or the other related but dissimilar chunks of data. All operations are conducted within the user's local system. No data is presented externally.

Each of the above chunks does not contain location information for any other dissimilar chunks. This provides for, security of data content, a basis for integrity checking and redundancy.

The method further comprises the step of only allowing the person (or group) to whom the data belongs, to have access to it, preferably via a shared encryption technique. This allows persistence of data.

The checking of data or chunks of data between machines is carried out via any presence type protocol such as a distributed hash table network.

On the occasion when all data chunks have been relocated (i.e. the user has not logged on for a while) a redirection record is created and stored in the super node network, (a three copy process—similar to data) therefore when a user requests a check, the redirection record is given to the user to update their database.

This efficiently allows data resilience in cases where network churn is a problem as in peer to peer or distributed networks.

With reference to FIG. 7 which illustrates flow chart example of file chunking. User's normal file has 5 Mb document, which is chunked into smaller variable sizes e.g. 135 kb, 512 kb, 768 kb in any order. All chunks may be compressed and encrypted by using Pass phrase. Next step is to individually hash chunks and given hashes as names. Then database record as a file is made from names of hashed chunks brought together e.g. in empty version of original file (C1########, t1, t2, t3: C2########, t1, t2, t3 etc), this file is then sent to transmission queue in storage space allocated to client application.

With reference to FIG. 8 provides a self healing event sequence methodology. Self healing is required to guarantee availability of accurate data. As data or chunks become invalid by failing integrity test by step (110). The location of failing data chunks is assessed as unreliable and further data from the leaf node is ignored from that location by step (120). A ‘Good Copy’ from the ‘known good’ data chunk is recreated in a new and equivalent leaf node. Data or chunks are recreated in a new and safer location by step (130). The leaf node with failing data chunks is marked as unreliable and the data therein as ‘dirty’ by step (140). Peer leaf nodes become aware of this unreliable leaf node and add its location to watch list by step (150). All operations conducted within the user's local system. No data is presented externally.

Therefore, the introduction of viruses, worms etc. will be prevented and faulty machines/equipment identified automatically.

The network will use SSL or TLS type encryption to prevent unauthorised access or snooping.

With reference to FIG. 9, Peer Ranking id required to ensure consistent response and performance for the level of guaranteed interaction recorded for the user. For Peer Ranking each node (leaf node) monitors its own peer node's resources and availability in a scaleable manner, each leaf node is constantly monitored.

Each data store (whether a network service, physical drive etc.) is monitored for availability. A qualified availability ranking is appended to the (leaf) storage node address by consensus of a monitoring super node group by step (160). A ranking figure will be appended by step (160) and signed by the supply of a key from the monitoring super node; this would preferably be agreed by more super nodes to establish a consensus for altering the ranking of the node. The new rank will preferably be appended to the node address or by a similar mechanism to allow the node to be managed preferably in terms of what is stored there and how many copies there has to be of the data for it to be seen as perpetual.

Each piece of data is checked via a content hashing mechanism for data integrity, which is carried out by the storage node itself by step (170) or by its partner nodes via super nodes by step (180) or by instigating node via super nodes by step (190) by retrieval and running the hashing algorithm against that piece of data. The data checking cycle repeats itself.

As a peer (whether an instigating node or a partner peer (i.e. one that has same chunk)) checks the data, the super node querying the storage peer will respond with the result of the integrity check and update this status on the storage peer. The instigating node or partner peer will decide to forget this data and will replicate it in a more suitable location.

If data fails the integrity check the node itself will be marked as ‘dirty’ by step (200) and ‘dirty¹ status appended to leaf node address to mark it as requiring further checks on the integrity of the data it holds by step (210). Additional checks are carried out on data stored on the leaf node marked as ‘dirty’ by step (220). If pre-determined percentage of data found to be ‘dirty’ node is removed from the network except for message traffic by step (230). A certain percentage of dirty data being established may conclude that this node is compromised or otherwise damaged and the network would be informed of this. At that point the node will be removed from the network except for the purpose of sending it warning messages by step (230).

This allows either having data stored on nodes of equivalent availability and efficiency or dictating the number of copies of data required to maintain reliability.

Further modifications and improvements may be added without departing from the scope of the invention herein described.

With reference to FIG. 10, duplicate data is removed to maximise the efficient use of the disk space. Prior to the initiation of the data backup process by step (240), internally generated content hash may be checked for a match against hashes stored on the internet by step (250) or a list of previously backed up data (250). This will allow only one backed up copy of data to be kept. This reduces the network wide requirement to backup data which has the exact same contents. Notification of shared key existence is passed back to instigating node by step (260) to access authority check requested, which has to pass for signed result is to be passed back to storage node. The storage node passes shared key and database back to instigating node by step (270)

Such data is backed up via a shared key which after proof of the file existing (260) on the instigating node, the shared key (270) is shared with this instigating node. The location of the data is then passed to the node for later retrieval if required.

This maintains copyright as people can only backup what they prove to have on their systems and not publicly share copyright infringed data openly on the network.

This data may be marked as protected or not protected by step (280) which has check carried out for protected or non-protected data content. The protected data ignores sharing process.

msSAN

According to a related aspect of this invention: the ability to seed or allow nodes to gain acceptance on a network (such as described below) will require that validation or approval is met somehow. This is carried out in this case by the addition of a seeding ID and associated key pair. This key pair will allow the public key to be fed down the chain to authenticating nodes to validate themselves and consequently gain access to the network and then they themselves can become seeding nodes using their ID as the seeding ID for nodes further down the hierarchy.

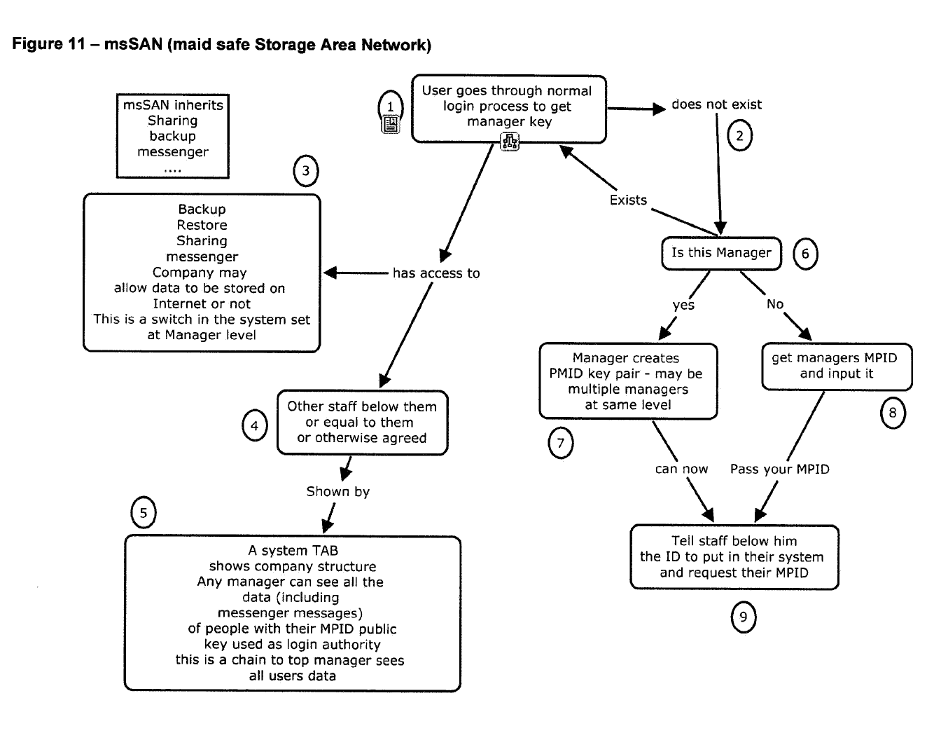

### Maid Safe Storage Area Network (FIG. 11)

1. A user looks for his manager's key locally or more likely in his database (retrieved via TMID chunk).

2. If he has a manager's key then he can proceed as usual.

3. The user can then access his data/backup restore messaging systems etc.

4. The user can see that staff that have used his key or any other key down the signing chain from him.

5. A tab in the system shows the company structure, clicking on this a user (if he has rights) can look at all data available to that user including messenger messages etc. He can withdraw the service (if he has the particular authority to do so) at any time from this person by revoking his key. This key is stored on the Authority Chunk on the net which is a chunk named the hash of the public key on the manager. This chunk includes all staff that can access the system with this public key as the authorisation mechanism. If a staff member cannot authenticate against any of the authority chunks he cannot use the system.

6. If this is the manager (i.e. first user to be set up which should be company leader or preferably teams of leaders, for security.)

7. Then the manager (or preferably team) creates a maidsafe.net public ID (MPID) along with his usual MID PMID etc.

8. If the initiator is not a manager, they may be an unauthorised user—to get authorised, a manager must give his MPID and get that user's MPID back to complete the challenge response.

9. The user can then authenticate staff organisationally below him or other staff that he is allowed to authenticate given company policy. Who can authenticate what users will be found on the company structure program tab.

According to a related aspect of this invention, preferably a key sharing scheme such as:

Two points uniquely define a line, three points define a parabola, four define a cubic curve, etc. More generally, n coordinate pairs (xi, yi) uniquely define a polynomial of degree n−1. The dealer encodes the secret as the curve's y-intercept and gives each player the coordinates of a point on this curve. When the players pool together enough shares, they can interpolate to find the y-intercept and thus recover the secret.

It would be impractical to use this scheme with conventional polynomials; the secret and the shares would generally be complex fractions that are difficult to store in a typical file. Consequently, the polynomial is typically defined over a finite field instead.

Shamir's scheme is space-efficient; each share is the same size as the original secret because the x-coordinates of each share can be known to all the players. This scheme also minimizes the need for random numbers; for every bit in the secret, the dealer must generate t random bits, where t is the threshold number of people.”
. . . taken from Wikipedia http://en.wikipedia.org/wiki/Secret_sharing

This allows the leader or manager of the company to be able to access the overall company key when needed, but in an emergency any 3 of the 12 board members or similar should be able to unlock the secret key together. This can be accomplished by a secret sharing scheme with t=3 and n=15, where 3 shares are given to the president or leader etc., and 1 is given to each board member.

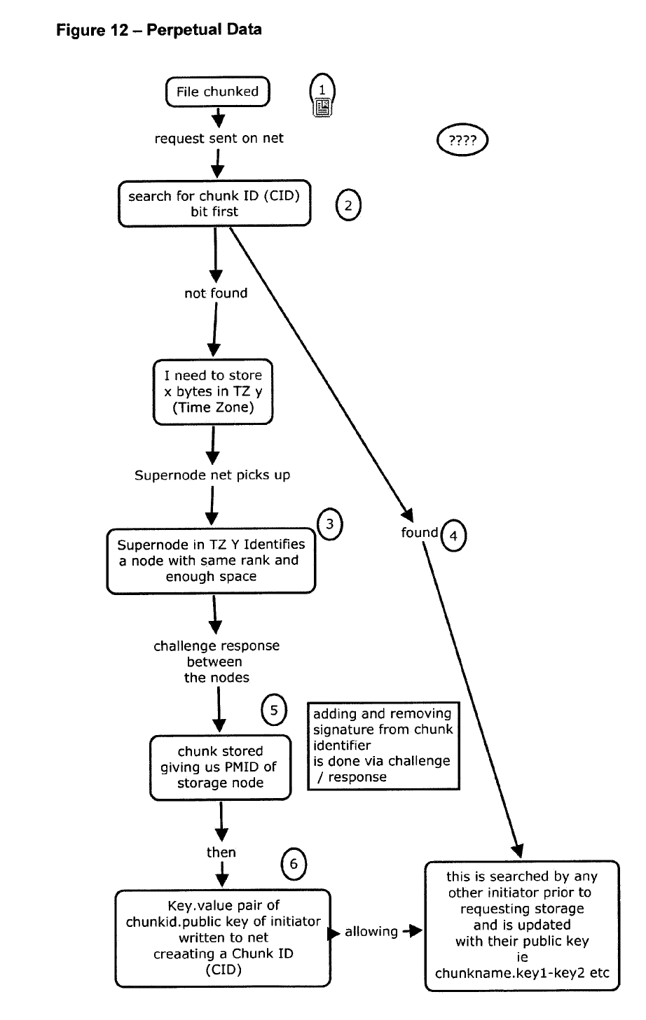

### Perpetual Data (FIG. 1—PT1 and FIG. 12)

According to a related aspect of this invention, a file is chunked or split into constituent parts (1) this process involves calculating the chunk size, preferably from known data such as the first few bytes of the hash of the file itself and preferably using a modulo division technique to resolve a figure between the optimum minimum and optimum maximum chunk sizes for network transmission and storage.

Preferably each chunk is then encrypted and obfuscated in some manner to protect the data. Preferably a search of the network is carried out looking for values relating to the content hash of each of the chunks (2).

If this is found (4) then the other chunks are identified too, failure to identify all chunks may mean there is a collision on the network of file names or some other machine is in the process of backing up the same file. A back-off time is calculated to check again for the other chunks. If all chunks are on the network the file is considered backed up and the user will add their MID signature to the file after preferably a challenge response to ensure there a valid user and have enough resources to do this.

If no chunks are on the net the user preferably via another node (3) will request the saving of the first copy (preferably in distinct time zones or other geographically dispersing method).

The chunk will be stored (5) on a storage node allowing us to see the PMID of the storing node and store this.

Then preferably a Key.value pair of chunkid. public key of initiator is written to net creating a Chunk ID (CID) (6)

### Storage and Retrieval (FIG. 1—P4)

According to a related aspect of this invention, the data is stored in multiple locations. Each location stores the locations of its peers that hold identical chunks (at least identical in content) and they all communicate regularly to ascertain the health of the data. The preferable method is as follows:

Preferably the data is copied to at least three disparate locations.

Preferably each copy is performed via many nodes to mask the initiator.

Preferably each local copy is checked for validity and checks are made that the preferably other 2 copies are also still valid.

Preferably any single node failure initiates a replacement copy being made in another disparate location and the other associated copies are updated to reflect this change.

Preferably the steps of storing and retrieving are carried out via other network nodes to mask the initiator.

Preferably, the method further comprises the step of renaming all files with a hash of their contents.

Preferably each chunk may alter its name by a known process such as a binary shift left of a section of the data. This allows the same content to exist but also allows the chunks to appear as three different bits of data for the sake of not colliding on the network.

Preferably each chunk has a counter attached to it that allows the network to understand easily just how many users are attached to the chunk—either by sharing or otherwise. A user requesting a ‘chunk forget¹ will initiate a system question if they are the only user using the chunk and if so the chunk will be deleted and the user's required disk space reduced accordingly. This allows users to remove files no longer required and free up local disk space. Any file also being shared is preferably removed from the user's quota and the user's database record or data map (see later) is deleted.

Preferably this counter is digitally signed by each node sharing the data and therefore will require a signed ‘forget’ or ‘delete’ command. Preferably even ‘store’, ‘put’, ‘retrieve’ and ‘get’ commands should also be either digitally signed or preferably go through a PKI challenge response mechanism.

To ensure fairness preferably this method will be monitored by a supernode or similar to ensure the user has not simply copied the data map for later use without giving up the disk space for it. Therefore the user's private ID public key will be used to request the forget chunk statement. This will be used to indicate the user's acceptance of the ‘chunk forget’ command and allow the user to recover the disk space. Any requests against the chunk will preferably be signed with this key and consequently rejected unless the user's system gives up the space required to access this file.

Preferably each user storing a chunk will append their signed request to the end of the chunk in an identifiable manner i.e. prefixed with 80—or similar.

Forgetting the chunk means the signature is removed from the file. This again is done via a signed request from the storage node as with the original backup request.

Preferably this signed request is another small chunk stored at the same location as the data chunk with an appended postfix to the chunk identifier to show a private ID is storing this chunk. Any attempt by somebody else to download the file is rejected unless they first subscribe to it, i.e. a chunk is called 12345 so a file is saved called 12345 <signed store request>. This will allow files to be forgotten when all signatories to the chunk are gone. A user will send a signed ‘no store’ or ‘forget’ and their ID chunk will be removed, and in addition if they are the last user storing that chunk, the chunk is removed. Preferably this will allow a private anonymous message to be sent upon chunk failure or damage allowing a proactive approach to maintaining clean data.

Preferably as a node fails the other nodes can preferably send a message to all sharers of the chunk to identify the new location of the replacement chunk.

Preferably any node attaching to a file then downloading immediately should be considered an alert and the system may take steps to slow down this node's activity or even halt it to protect data theft.

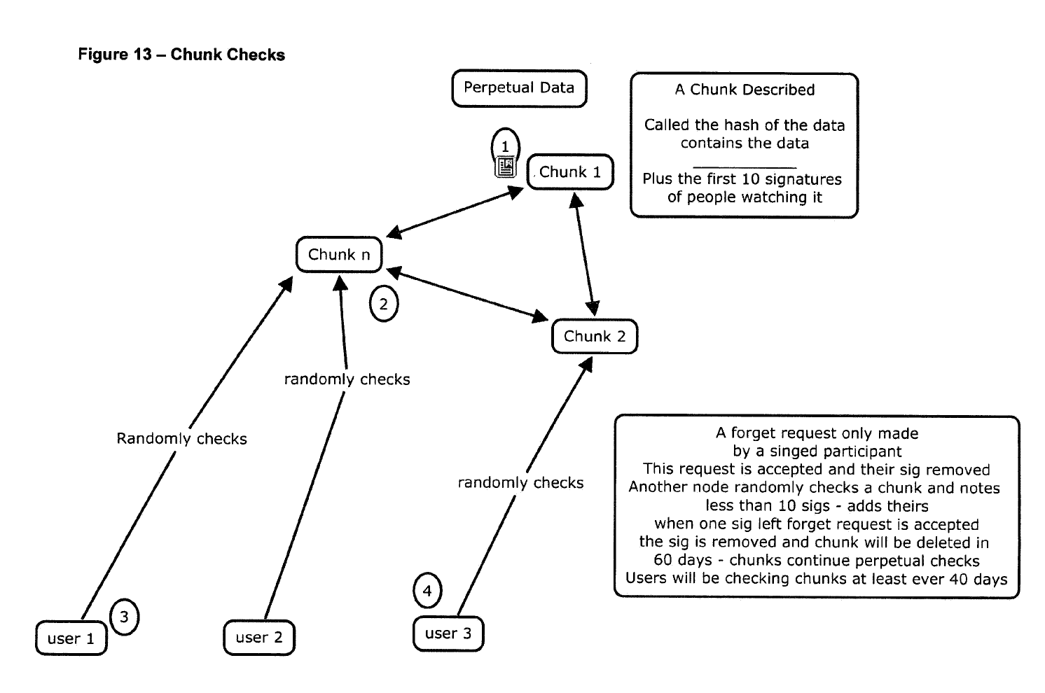

### Chunk Checks: (FIG. 1—P9 and FIG. 13)

1. Storage node containing chunk 1 checks its peers. As each peer is checked it reciprocates the check. These checks are split into preferably 2 types:
a. Availability check (i.e. simple network ping)
b. Data integrity check—in this instance the checking node takes a chunk and appends random data to it and takes a hash of the result. It then sends the random data to the node being checked and requests the hash of the chunk with the random data appended. The result is compared with a known result and the chunk will be assessed as either healthy or not. If not, further checks with other nodes occur to find the bad node.

2. There may be multiple storage nodes depending on the rating of machines and other factors. The above checking is carried out by all nodes from 1 to n (where n is total number of storage nodes selected for the chunk). Obviously a poorly rated node will require to give up disk space in relation to the number of chunks being stored to allow perpetual data to exist. This is a penalty paid by nodes that are switched off.

3. The user who stored the chunk will check on a chunk from 1 storage node randomly selected. This check will ensure the integrity of the chunk and also ensure there are at least 10 other signatures existing already for the chunk. If there are not and the user's ID is not listed, the user signs the chunk.

4. This shows another example of another user checking the chunk. Note that the user checks X (40 days in this diagram) are always at least 75% of the forget time retention (Y) (i.e. when a chunk is forgotten by all signatories it is retained for a period of time Y). This is another algorithm that will continually develop.

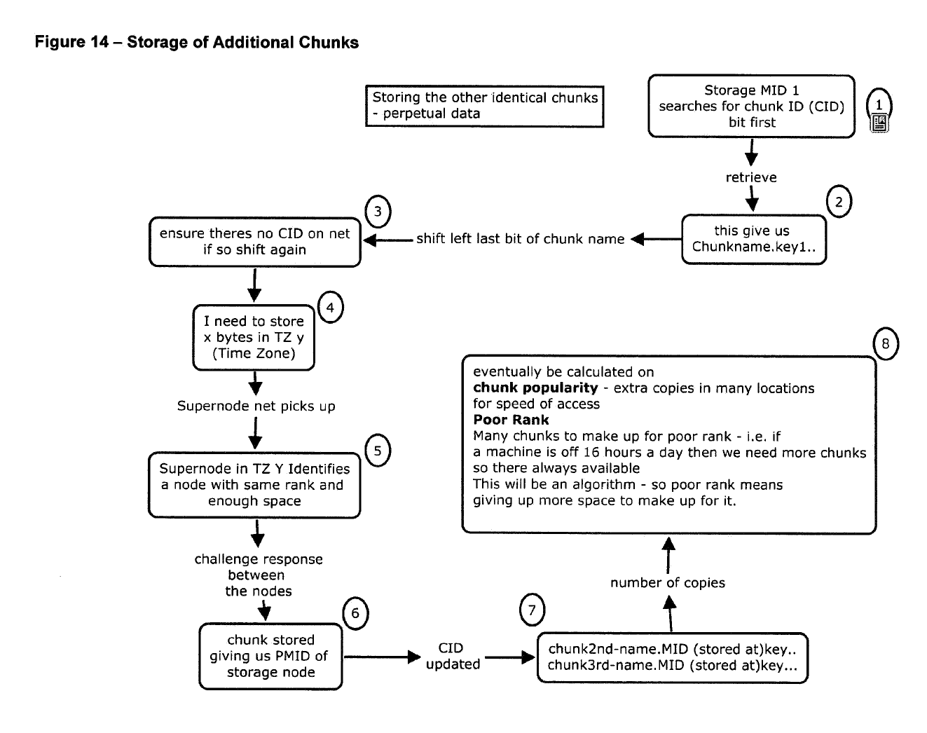

### Storage of Additional Chunks: (FIG. 14)

1. maidsafe.net program with user logged in (so MID exists) has chunked a file. It has already stored a chunk and is now looking to store additional chunks. Therefore a Chunk ID (CID) should exist on the net. This process retrieves this CID.

2. The CID as shown in storing initial chunk contains the chunk name and any public keys that are sharing the chunk. In this instance it should only be our key as we are first ones storing the chunks (others would be in a back-off period to see if we back other chunks up). We shift the last bit (could be any function on any bit as long as we can replicate it)

3. We then check we won't collide with any other stored chunk on the net—i.e. it does a CID search again.

4. We then issue our broadcast to our supernodes (i.e. the supernodes we are connected to) stating we need to store X bytes and any other information about where we require to store it (geographically in our case—time zone (TZ))

5. The supernode network finds a storage location for us with the correct rank etc.

6. The chunk is stored after a successful challenge response i.e. In the maidsafe.net network. MIDs will require to ensure they are talking or dealing with validated nodes, so to accomplish this a challenge process is carried out as follows: sender [S] receiver [R]
[S] I wish to communicate (store retrieve forget data etc.) and I am MAID
[R] retrieves MAID public key from DHT and encrypts a challenge (possibly a very large number encrypted with the public key retrieved)
[S] gets key and decrypts and encrypts [R] answer with his challenge number also encrypted with [R]¹S public key
[R] receives response and decrypts his challenge and passes back answer encrypted again with [S] public key
(Communication is now authenticated between these two nodes.)

7. The CID is then updated with the second chunk name and the location it is stored at. This process is repeated for as many copies of a chunk that are required.

8. Copies of chunks will be dependent on many factors including file popularity (popular files may require to be more dispersed closer to nodes and have more copies. Very poorly ranked machines may require an increased amount of chunks to ensure they can be retrieved at any time (poorly ranked machines will therefore have to give up more space.)

### Security Availability (FIG. 1—P3)

According to a related aspect of this invention, each file is split into small chunks and encrypted to provide security for the data. Only the person or the group, to whom the overall data belongs, will know the location of the other related but dissimilar chunks of data.

Preferably, each of the above chunks does not contain location information for any other dissimilar chunks; which provides for security of data content, a basis for integrity checking and redundancy.

Preferably, the method further comprises the step of only allowing the person (or group) to whom the data belongs to have access to it, preferably via a shared encryption technique which allows persistence of data.

Preferably, the checking of data or chunks of data between machines is carried out via any presence type protocol such as a distributed hash table network.

Preferably, on the occasion when all data chunks have been relocated, i.e. the user has not logged on for a while, a redirection record is created and stored in the super node network, (a three copy process—similar to data) therefore when a user requests a check, the redirection record is given to the user to update their database, which provides efficiency that in turn allows data resilience in cases where network churn is a problem as in peer to peer or distributed networks. This system message can be preferably passed via the messenger system described herein.

Preferably the system may simply allow a user to search for his chunks and through a challenge response mechanism, locate and authenticate himself to have authority to get/forget this chunk.

Further users can decide on various modes of operation preferably such as maintain a local copy of all files on their local machine, unencrypted or chunked or chunk and encrypt even local files to secure machine (preferably referred to as off line mode operation) or indeed users may decide to remove all local data and rely completely on preferably maidsafe.net or similar system to secure their data.

### Self Healing (FIG. 1—P2)

According to a related aspect of this invention, a self healing network method is provided via the following process;

As data or chunks become invalid—data is ignored from that location

Data or chunks are recreated in a new and safer location.

The original location is marked as bad.

Peers note this condition and add the bad location to a watch list.

This will prevent the introduction of viruses; worms etc. will allow faulty machines/equipment to be identified automatically.

Preferably, the network layer will use SSL or TLS channel encryption to prevent unauthorised access or snooping.

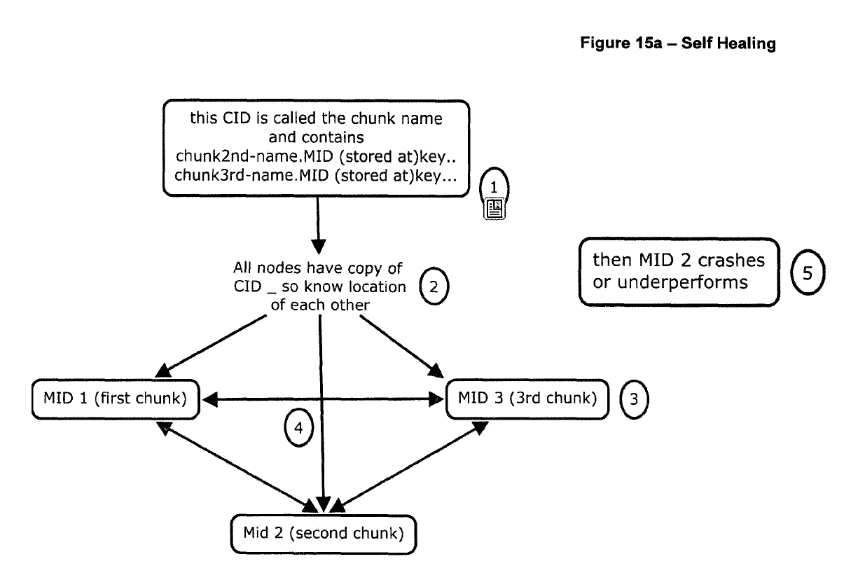

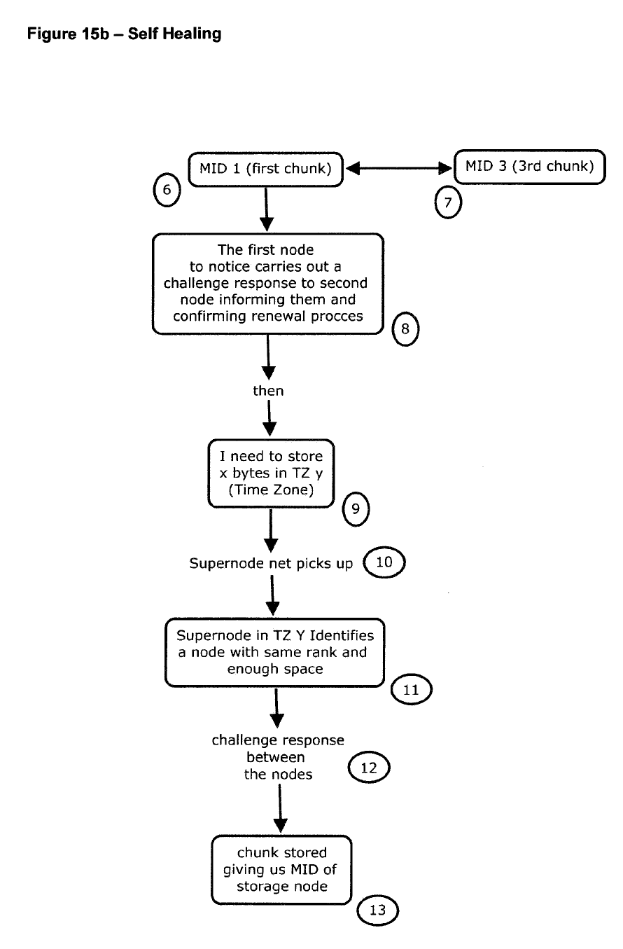

Self Healing (FIG. 15a/b)

1. A data element called a Chunk ID (CID) is created for each chunk. Added to this is the ‘also stored at¹ MID for the other identical chunks. The other chunk names are also here as they may be renamed slightly (i.e. by bit shifting a part of the name in a manner that calculable).

2. All storing nodes (related to this chunk) have a copy of this CID file or can access it at any stage from the DHT network, giving each node knowledge of all others.

3. Each of the storage nodes have their copy of the chunk.

4. Each node queries its partner's availability at frequent intervals. On less frequent intervals a chunk health check is requested. This involves a node creating some random data and appending this to it's chunk and taking the hash. The partner node will be requested to take the random data and do likewise and return the hash result. This result is checked against the result the initiator had and chunk is then deemed healthy or not. Further tests can be done as each node knows the hash their chunk should create and can self check n that manner on error and report a dirty node.

5. Now we have a node fail (creating a dirty chunk)

6. The first node to note this carries out a broadcast to other nodes to say it is requesting a move of the data.

7. The other nodes agree to have CID updated (they may carry out their own check to confirm this).

8. A broadcast is sent to the supernode network closest to the storage node that failed, to state a re-storage requirement.

9. The supernode network picks up the request.

10. The request is to the supernode network to store x amount of data at a rank of y.

11. A supernode will reply with a location

12. The storage node and new location carry out a challenge response request to validate each other.

13. The chunk is stored and the CID is updated and signed by the three or more nodes storing the chunk.

### Peer Ranking (FIG. 1—P1)

According to a related aspect of this invention, there is the addition of a peer ranking mechanism, where each node (leaf node) monitors its own peer node's resources and availability in a scalable manner. Nodes constantly perform this monitoring function.

Each data store (whether a network service, physical drive etc.) is monitored for availability. A ranking figure is appended and signed by the supply of a key from the monitoring super node, this being preferably agreed by more super nodes to establish a consensus before altering the ranking of the node. Preferably, the new rank will be appended to the node address or by a similar mechanism to allow the node to be managed in terms of what is stored there and how many copies there has to be of the data for it to be seen as perpetual.

Each piece of data is checked via a content hashing mechanism. This is preferably carried out by the storage node itself or by its partner nodes via super nodes or by an instigating node via super nodes by retrieving and running the hashing algorithm against that piece of data.

Preferably, as a peer (whether an instigating node or a partner peer (i.e. one that has same chunk)) checks the data, the super node querying the storage peer will respond with the result of the integrity check and update this status on the storage peer. The instigating node or partner peer will decide to forget this data and will replicate it in a more suitable location.

If data fails the integrity check, the node itself will be marked as ‘dirty’ and this status will preferably be appended to the node's address for further checks on other data to take this into account. Preferably a certain percentage of dirty data being established may conclude that this node is compromised or otherwise damaged and the network would be informed of this. At that point the node will be removed from the network except for the purpose of sending it warning messages.

In general, the node ranking figure will take into account at least; availability of the network connection, availability of resources, time on the network with a rank (later useful for effort based trust model), amount of resource (including network resources) and also the connectivity capabilities of any node (i.e. directly or indirectly contactable)

This then allows data to be stored on nodes of equivalent availability and efficiency, and to determine the number of copies of data required to maintain reliability.

### Encrypt—Decrypt (FIG. 1—P8)

According to a related aspect of this invention, the actual encrypting and decrypting is carried out via knowledge of the file's content and this is somehow maintained (see next). Keys will be generated and preferably stored for decrypting. Actually encrypting the file will preferably include a compression process and further obfuscation methods. Preferably the chunk will be stored with a known hash preferably based on the contents of that chunk.

Decrypting the file will preferably require the collation of all chunks and rebuilding of the file itself. The file may preferably have its content mixed up by an obfuscation technique rendering each chunk useless on its own.

Preferably every file will go through a process of byte (or preferably bit) swapping between its chunks to ensure the original file is rendered useless without all chunks.

This process will preferably involve running an algorithm which preferably takes the chunk size and then distributes the bytes in a pseudo random manner preferably taking the number of chunks and using this as an iteration count for the process. This will preferably protect data even in event of somebody getting hold of the encryption keys—as the chunks data is rendered useless even if transmitted in the open without encryption.

This defends against somebody copying all data and storing for many years until decryption of today's algorithms is possible, although this is many years away.

This also defends against somebody; instead of attempting to decrypt a chunk by creating the enormous amount of keys possible, (in the region of 2̂54) rather instead creating the keys and presenting chunks to all keys—if this were possible (which is unlikely) a chunk would decrypt. The process defined here makes this attempt useless.

All data will now be considered to be diluted throughout the original chunks and preferably additions to this algorithm will only strengthen the process.

### Identify Chunks (FIG. 1—P9)

According to a related aspect of this invention, a chunk's original hash or other calculable unique identifier will be stored. This will be stored with preferably the final chunk name. This aspect defines that each file will have a separate map preferably a file or database entry to identify the file and the name of its constituent parts. Preferably this will include local information to users such as original location and rights (such as a read only system etc.). Preferably some of this information can be considered shareable with others such as filename, content hash and chunks names.

ID Data with Small File (FIG. 1—P11)

According to a related aspect of this invention, these data maps may be very small in relation to the original data itself allowing transmission of files across networks such as the internet with extreme simplicity, security and bandwidth efficiency. Preferably the transmission of maps will be carried out in a very secure manner, but failure to do this is akin to currently emailing a file in its entirety.

This allows a very small file such as the data map or database record to be shared or maintained by a user in a location not normally large enough to fit a file system of any great size, such as on a PDA or mobile phone. The identification of the chunk names, original names and final names are all that is required to retrieve the chunks and rebuild the file with certainty.

With data maps in place a user's whole machine, or all its data, can exist elsewhere. Simply retrieving the data maps of all data, is all that is required to allow the user to have complete visibility and access to all their data as well as any shared files they have agreed to.

### Revision Control (FIG. 1—P10)

According to a related aspect of this invention, as data is updated and the map contents alter to reflect the new contents, this will preferably not require the deletion or removal of existing chunks, but instead allow the existing chunks to remain and the map appended to with an indication of a new revision existing. Preferably further access to the file will automatically open the last revision unless requested to open an earlier revision.

Preferably revisions of any file can be forgotten or deleted (preferably after checking the file counter or access list of sharers as above). This will allow users to recover space from no longer required revisions.

### Share Maps (FIG. 1—P16)

According to a related aspect of this invention, this map of maps will preferably identify the users connected to it via some public ID that is known to each other user, with the map itself will being passed to users who agree to join the share. This will preferably be via an encrypted channel such as ms messenger or similar. This map may then be accessed at whatever rank level users have been assigned. Preferably there will be access rights such as read/delete/add/edit as is typically used today. As a map is altered, the user instigating this is checked against the user list in the map to see if this is allowed. If not, the request is ignored but preferably the users may then save the data themselves to their own database or data maps as a private file or even copy the file to a share they have access rights for. These shares will preferably also exhibit the revision control mechanism described above.

Preferably joining the share will mean that the users subscribe to a shared amount of space and reduce the other subscription, i.e. a 10 Gb share is created then the individual gives up 10 Gb (or equivalent dependent on system requirements which may be a multiple or divisor of 10 Gb). Another user joining means they both have a 5 Gb space to give up and 5 users would mean they all have a 2 Gb or equivalent space to give up. So with more people sharing, requirements on all users reduce.

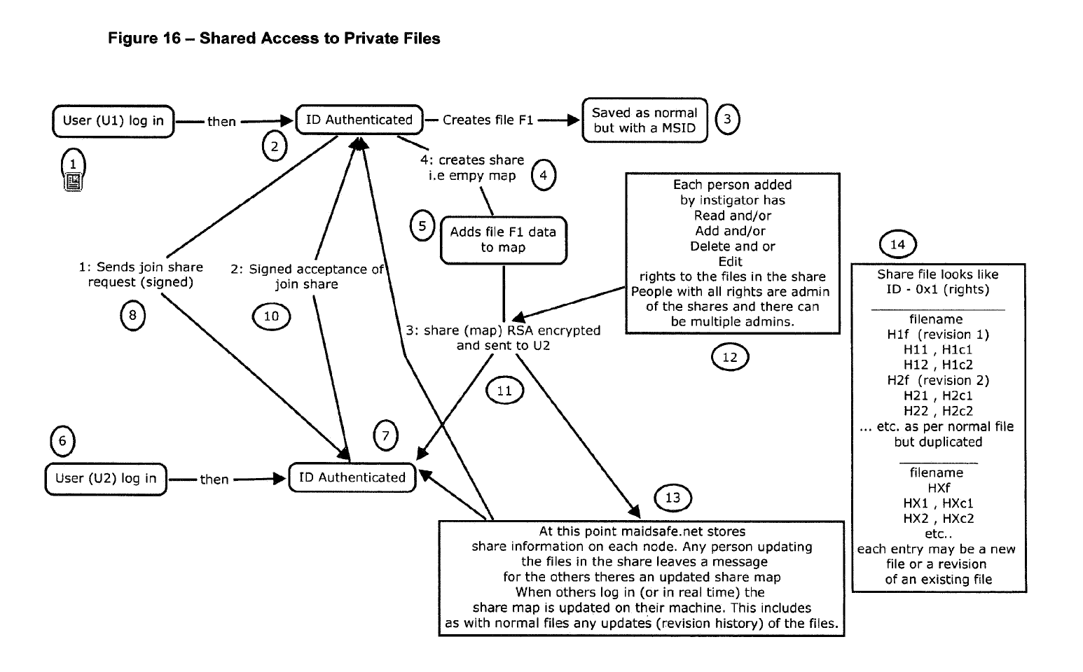

### Shared Access to Private Files (FIG. 1—PT5 and FIG. 16)

1. User 1 logs on to network

2. Authenticates ID—i.e. gets access to his public and private keys to sign messages. This should NOT be stored locally but should have been retrieved from a secure location—anonymously and securely.

3. User 1 saves a file as normal (encrypted, obfuscated, chunked, and stored on the net via a signed and anonymous ID. This ID is a special maidsafe.net Share ID (MSID) and is basically a new key pair created purely for interacting with the share users—to mask the user's MID (i.e. cannot be tied to MPID via a share). So again the MSID is a key pair and the ID is the hash of the public key—this public key is stored in a chunk called the hash and signed and put on the net for others to retrieve and confirm that the public key belongs to the hash.

4. User creates a share—which is a data map with some extra elements to cover users and privileges.

5. File data added to file map is created in the backup process, with one difference, this is a map of maps and may contain many files—see 14

6. User 2 logs in

7. User 2 has authentication details (i.e. their private MPID key) and can sign/decrypt with this MPID public key.

8. User 1 sends a share join request to user 2 (shares are invisible on the net—i.e. nobody except the sharers to know they are there).

9. User 1 signs the share request to state he will join share. He creates his MSID key pair at this time. The signed response includes User 2's MSID public key.

10. Share map is encrypted or sent encrypted (possibly by secure messenger) to User 1 along with the MSID public keys of any users of the share that exist. Note the transmission of MSID public key may not be required as the MSID chunks are saved on the net as described in 3 so any user can check the public key at any time—this just saves the search operation on that chunk to speed the process up slightly.

11. Each user has details added to the share these include public name (MPID) and rights (read/write/delete/admin etc.)

12. A description of the share file

Note that as each user saves new chunks he does so with the MSID keys, this means that if a shares is deleted or removed the chunks still exist in the users home database and he can have the option to keep the data maps and files as individual files or simply forget them all.

Note also that as a user opens a file, a lock is transmitted to all other shares and they will only be allowed to open a file read only—they can request unlock (i.e. another user unlocks the file—meaning it becomes read only). Non-logged in users will have a message buffered for them—if the file is closed the buffered message is deleted (as there is no point in sending it to the user now) and logged in users are updated also.

This will take place using the messenger component of the system to automatically receive messages from share users about shares (but being limited to that).

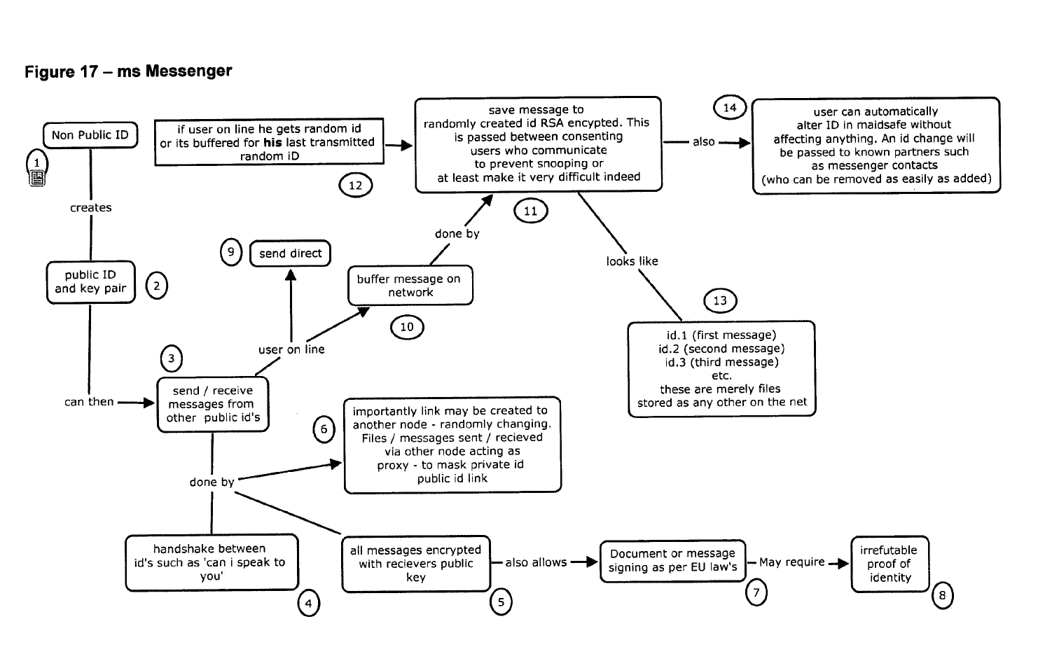

ms_messenger (FIG. 1—PT6 and FIG. 17)

1. A non public ID preferably one which is used in some other autonomous system is used as a sign in mechanism and creates a Public ID key pair.

2. The user selects or creates their public ID by entering a name that can easily be remembered (such as a nickname) the network is checked for a data element existing with a hash of this and if not there, this name is allowed. Otherwise the user is asked to choose again.

3. This ID called the MPID (maidsafe.net public ID) can be passed freely between friends or printed on business cards etc. as an email address is today.

4. To initiate communications a user enters the nickname of the person he is trying to communicate with along with perhaps a short statement (like a prearranged pin or other challenge). The receiver agrees or otherwise to this request, disagreeing means a negative score starts to build with initiator. This score may last for hours, days or even months depending on regularity of refusals. A high score will accompany any communication request messages. Users may set a limit on how many refusals a user has prior to being automatically ignored.

5. All messages now transmitted are done so encrypted with the receiving party's public key, making messages less refutable.

6. These messages may go through a proxy system or additional nodes to mask the location of each user.

7. This system also allows document signing (digital signatures) and interestingly, contract conversations. This is where a contract is signed and shared between the users. Preferably this signed contract is equally available to all in a signed (non changeable manner) and retrievable by all. Therefore a distributed environment suits this method. These contracts may be NDAs Tenders, Purchase Orders etc.

8. This may in some cases require individuals to prove their identity and this can take many forms from dealing with drivers licenses to utility bills being signed off in person or by other electronic methods such as inputting passport numbers, driving license numbers etc.

9. If the recipient is on line then messages are sent straight to them for decoding.

10. If the recipient is not on line, messages are require to be buffered as required with email today.

11. Unlike today's email though, this is a distributed system with no servers to buffer to. In maidsafe.net messages are stored on the net encrypted with the receiver's public key. Buffer nodes may be known trusted nodes or not.

12. Messages will look like receivers id. message 1. message 2 or simply be appended to the users MPID chunk, in both cases messages are signed by the sender. This allows messages to be buffered in cases where the user is offline. When the user comes on line he will check his ID chunk and look for appended messages as above ID.messageI etc. which is MPID.<message 1 data>.<message 2 data> etc

This system allows the ability for automatic system messages to be sent, i.e . . . in the case of sharing the share, data maps can exist on everyone's database and never be transmitted or stored in the open. File locks and changes to the maps can automatically be routed between users using the messenger system as described above. This is due to the distributed nature of maidsafe.net and is a great, positive differentiator from other messenger systems. These system commands will be strictly limited for security reasons and will initially be used to send alerts from trusted nodes and updates to share information by other shares of a private file share (whether they are speaking with them or not).

The best way within our current power to get rid of email spam is to get rid of email servers.

1. A system with granular accessibility to data in distributed network or corporate network that allows one to access any computer via this system and have their own data and desktop represented to them as well as the ability to access digital resources without involving third party access controls or dedicated servers, the system comprising the following steps:
providing a perpetual data system to ensure there are several copies of each piece of data at several geographic locations generated by algorithms which monitor each other and create further copies on any type of failure or corruption of a single copy;
providing an anonymous authentication system to allow authentication access to a distributed system comprising the steps of; receiving a user identifier; retrieving an encrypted validation record identified by the user identifier; decrypting the encrypted validation record so as to provide decrypted information; and authenticating access to data in the distributed file system using the decrypted information to provide anonymous authentication; and
providing a n+p key sharing system to allow users to log in with a created base ID, the ID is validated from a supervising node—a manager, users are provided with a further key (Manager's key) to allow access by manager and the corporate structure decided upon can be viewed as a tree and accessed as such to provide access to all users' data beneath or equivalent in some cases to the current user level;
wherein the above combination provides a unique system with cumulative and synergistic benefits to allow people to effectively control access to their own digital resources without using servers, anonymous authentication of users, with an assurity of a self healing, fault resistant, and duplicate removal network and corporate tree network.

2. A product with granular accessibility to data in distributed network or corporate network that allows one to access any computer via this product and have their own data and desktop represented to them as well as the ability to access digital resources without involving 3^{rd} party access controls or dedicated servers, the product comprising the following steps:
providing a perpetual data product to ensure there are several copies of each piece of data at several geographic locations generated by algorithms which monitor each other and create further copies on any type of failure or corruption of a single copy, and comprises of synergistic steps of storage & retrieval, self-healing, security availability and peer ranking;
providing an anonymous authentication product to allow authentication access to a distributed system comprising of; receiving a user identifier;
retrieving an encrypted validation record identified by the user identifier;
decrypting the encrypted validation record so as to provide decrypted information; and authenticating access to data in the distributed file system using the decrypted information to provide anonymous authentication; and
providing a n+p key sharing product to allow users to log in with a created base ID, the ID is validated from a supervising node—a manager, users are provided with a further key (Manager's key) to allow access by manager and the corporate structure decided upon can be viewed as a tree and accessed as such to provide access to all users' data beneath or equivalent in some cases to the current user level;
wherein, the above combination provides a unique product with cumulative and synergistic benefits to allow people to effectively control access to their own digital resources without using servers, anonymous authentication of users, with an assurity of a self healing, fault resistant, and duplicate removal network and corporate tree network.

3. The system of claim 1 further comprising a self-encryption system that allows one to access any computer via this system and have their own data and desktop represented to them as well as the ability to secure digital resources without involving third party access controls or dedicated servers, the self-encryption system comprising the following steps:
providing a perpetual data system to ensure there are several copies of each piece of data at several geographic locations generated by algorithms which monitor each other and create further copies on any type of failure or corruption of a single copy;
providing a self encryption system to allow the data to be chunked, renamed, byte or bit swapped, encrypted and compressed through algorithms seeded by elements derived from the data itself so that data holds the key to reversing the processes used and these are recorded for later use and aids security and duplicate removal on a network wide basis;
providing a n+p key sharing system to allow users to log in with a created base ID, the ID is validated from a supervising node—a manager, users are provided with a further key (Manager's key) to allow access by manager and the corporate structure decided upon can be viewed as a tree and accessed as such to provide access to all users' data beneath or equivalent in some cases to the current user level; and
providing an anonymous authentication system to allow authentication access to a distributed system comprising the steps of; receiving a user identifier; retrieving an encrypted validation record identified by the user identifier; decrypting the encrypted validation record so as to provide decrypted information; and authenticating access to data in the distributed file system using the decrypted information to provide anonymous authentication;
wherein, the above combination provides a unique system with cumulative and synergistic benefits to allow people to effectively control access to their own digital resources and securely store data without using servers, anonymous authentication of users, with an assurity of a self healing, fault resistant, and duplicate removal network and corporate tree network.

4. The product of claim 2 further comprising a self-encryption system that allows one to access any computer via this system and have their own data and desktop represented to them as well as the ability to secure digital resources without involving third party access controls or dedicated servers, the self-encryption system comprising the following steps:
providing a perpetual data system to ensure there are several copies of each piece of data at several geographic locations generated by algorithms which monitor each other and create further copies on any type of failure or corruption of a single copy;
providing a self encryption system to allow the data to be chunked, renamed, byte or bit swapped, encrypted and compressed through algorithms seeded by elements derived from the data itself so that data holds the key to reversing the processes used and these are recorded for later use and aids security and duplicate removal on a network wide basis;
providing a n+p key sharing system to allow users to log in with a created base ID, the ID is validated from a supervising node—a manager, users are provided with a further key (Manager's key) to allow access by manager and the corporate structure decided upon can be viewed as a tree and accessed as such to provide access to all users' data beneath or equivalent in some cases to the current user level; and
providing an anonymous authentication system to allow authentication access to a distributed system comprising the steps of; receiving a user identifier; retrieving an encrypted validation record identified by the user identifier; decrypting the encrypted validation record so as to provide decrypted information; and authenticating access to data in the distributed file system using the decrypted information to provide anonymous authentication;
wherein, the above combination provides a unique system with cumulative and synergistic benefits to allow people to effectively control access to their own digital resources and securely store data without using servers, anonymous authentication of users, with an assurity of a self healing, fault resistant, and duplicate removal network and corporate tree network.

5. The system of claim 1 further comprising a data maps system that allows one to access any computer via this system and have their own data and desktop represented to them as well as the ability to secure digital resources without involving third party access controls or dedicated servers, the system comprising the following steps:
providing a perpetual data system to ensure there are several copies of each piece of data at several geographic locations generated by algorithms which monitor each other and create further copies on any type of failure or corruption of a single copy;
providing a self encryption system to allow the data to be chunked, renamed, byte or bit swapped, encrypted and compressed through algorithms seeded by elements derived from the data itself so that data holds the key to reversing the processes used and these are recorded for later use and aids security and duplicate removal on a network wide basis;
providing a n+p key sharing system to allow users to log in with a created base ID, the ID is validated from a supervising node—a manager, users are provided with a further key (Manager's key) to allow access by manager and the corporate structure decided upon can be viewed as a tree and accessed as such to provide access to all users' data beneath or equivalent in some cases to the current user level;
providing a data maps system to allow creation of a database or ‘map’ of associated file chunks and their identifiers and provides a mechanism that allows data that has preferably been split into chunks, to be stored, managed and accessed in a way that guarantees its convenient and secure availability to its owner(s); and
providing an anonymous authentication system to allow authentication access to a distributed system comprising the steps of; receiving a user identifier; retrieving an encrypted validation record identified by the user identifier; decrypting the encrypted validation record so as to provide decrypted information; and authenticating access to data in the distributed file system using the decrypted information to provide anonymous authentication;
wherein, the above combination provides a unique system with cumulative and synergistic benefits to allow people to effectively control access to their own digital resources and securely store data without using servers, anonymous authentication of users, with an assurity of a self healing, fault resistant, and duplicate removal network and corporate tree network.

6. The product of claim 2 further comprising data maps product that allows one to access any computer via this product and have their own data and desktop represented to them as well as the ability to secure digital resources without involving third party access controls or dedicated servers, the product comprising the following steps:
providing a perpetual data system to ensure there are several copies of each piece of data at several geographic locations generated by algorithms which monitor each other and create further copies on any type of failure or corruption of a single copy;
providing a self encryption system to allow the data to be chunked, renamed, byte or bit swapped, encrypted and compressed through algorithms seeded by elements derived from the data itself so that data holds the key to reversing the processes used and these are recorded for later use and aids security and duplicate removal on a network wide basis;
providing a n+p key sharing system to allow users to log in with a created base ID, the ID is validated from a supervising node—a manager, users are provided with a further key (Manager's key) to allow access by manager and the corporate structure decided upon can be viewed as a tree and accessed as such to provide access to all users' data beneath or equivalent in some cases to the current user level;
providing a data maps system to allow creation of a database or ‘map’ of associated file chunks and their identifiers and provides a mechanism that allows data that has preferably been split into chunks, to be stored, managed and accessed in a way that guarantees its convenient and secure availability to its owner(s); and
providing an anonymous authentication system to allow authentication access to a distributed system comprising the steps of; receiving a user identifier; retrieving an encrypted validation record identified by the user identifier; decrypting the encrypted validation record so as to provide decrypted information; and authenticating access to data in the distributed file system using the decrypted information to provide anonymous authentication;
wherein, the above combination provides a unique system with cumulative and synergistic benefits to allow people to effectively control access to their own digital resources and securely store data without using servers, anonymous authentication of users, with an assurity of a self healing, fault resistant, and duplicate removal network and corporate tree network.

7. The system of claim 1 further comprising shared access to private system that allows one to access any computer via this system and have their own data and desktop represented to them as well as the ability to securely share digital resources without involving third party access controls or dedicated servers, the system comprising the following steps:
providing a perpetual data system to ensure there are several copies of each piece of data at several geographic locations generated by algorithms which monitor each other and create further copies on any type of failure or corruption of a single copy;
providing a self encryption system to allow the data to be chunked, renamed, byte or bit swapped, encrypted and compressed through algorithms seeded by elements derived from the data itself so that data holds the key to reversing the processes used and these are recorded for later use and aids security and duplicate removal on a network wide basis;
providing a n+p key sharing system to allow users to log in with a created base ID, the ID is validated from a supervising node—a manager, users are provided with a further key (Manager's key) to allow access by manager and the corporate structure decided upon can be viewed as a tree and accessed as such to provide access to all users' data beneath or equivalent in some cases to the current user level;
providing a Data maps system to allow creation of a database or ‘map¹ of associated file chunks and their identifiers and provides a mechanism that allows data that has preferably been split into chunks, to be stored, managed and accessed in a way that guarantees its convenient and secure availability to its owner(s);
providing an anonymous authentication system to allow authentication access to a distributed system comprising the steps of; receiving a user identifier; retrieving an encrypted validation record identified by the user identifier; decrypting the encrypted validation record so as to provide decrypted information; and authenticating access to data in the distributed file system using the decrypted information to provide anonymous authentication; and
providing a hared access to private files system to allow users to share concatenated data maps in a shared environment without requiring any additional physical resources such as servers, discs etc. by steps of, provision of public ID₁ encrypted communication and identifying data with very small file;
wherein, the above combination provides a unique system with cumulative and synergistic benefits to allow people to effectively control access to their own digital resources and securely store data, share private files & secure data without using servers, anonymous authentication of users, with an assurity of a self healing, fault resistant, and duplicate removal network and corporate tree network.

8. The product of claim 2 further comprising shared access to private product that allows one to access any computer via this product and have their own data and desktop represented to them as well as the ability to securely share digital resources without involving third party access controls or dedicated servers, the product comprising the following steps:
providing a perpetual data system to ensure there are several copies of each piece of data at several geographic locations generated by algorithms which monitor each other and create further copies on any type of failure or corruption of a single copy;
providing a self encryption system to allow the data to be chunked, renamed, byte or bit swapped, encrypted and compressed through algorithms seeded by elements derived from the data itself so that data holds the key to reversing the processes used and these are recorded for later use and aids security and duplicate removal on a network wide basis;
providing a n+p key sharing system to allow users to log in with a created base ID, the ID is validated from a supervising node—a manager, users are provided with a further key (Manager's key) to allow access by manager and the corporate structure decided upon can be viewed as a tree and accessed as such to provide access to all users' data beneath or equivalent in some cases to the current user level;
providing a Data maps system to allow creation of a database or ‘map¹ of associated file chunks and their identifiers and provides a mechanism that allows data that has preferably been split into chunks, to be stored, managed and accessed in a way that guarantees its convenient and secure availability to its owner(s);
providing an anonymous authentication system to allow authentication access to a distributed system comprising the steps of; receiving a user identifier; retrieving an encrypted validation record identified by the user identifier; decrypting the encrypted validation record so as to provide decrypted information; and authenticating access to data in the distributed file system using the decrypted information to provide anonymous authentication; and
providing a hared access to private files system to allow users to share concatenated data maps in a shared environment without requiring any additional physical resources such as servers, discs etc. by steps of, provision of public ID₁ encrypted communication and identifying data with very small file;
wherein, the above combination provides a unique system with cumulative and synergistic benefits to allow people to effectively control access to their own digital resources and securely store data, share private files & secure data without using servers, anonymous authentication of users, with an assurity of a self healing, fault resistant, and duplicate removal network and corporate tree network.

9. The system of claim 1 further comprising MS messenger system that allows one to access any computer via this system and have their own data and desktop represented to them as well as the ability to communicate securely and share digital resources without involving third party access controls or dedicated servers, the system comprising the following steps:
providing a Perpetual data system to ensure there are several copies of each piece of data at several geographic locations generated by algorithms which monitor each other and create further copies on any type of failure or corruption of a single copy;
providing a self encryption system to allow the data to be chunked, renamed, byte or bit swapped, encrypted and compressed through algorithms seeded by elements derived from the data itself so that data holds the key to reversing the processes used and these are recorded for later use and aids security and duplicate removal on a network wide basis;
providing a n+p key sharing system to allow users to log in with a created base ID, the ID is validated from a supervising node—a manager, users are provided with a further key (Manager's key) to allow access by manager and the corporate structure decided upon can be viewed as a tree and accessed as such to provide access to all users' data beneath or equivalent in some cases to the current user level;
providing a data maps system to allow the creation of a database or ‘map’ of associated file chunks and their identifiers and provides a mechanism that allows data that has preferably been split into chunks, to be stored, managed and accessed in a way that guarantees its convenient and secure availability to its owner(s);
providing an anonymous authentication system to allow authentication access to a distributed system comprising the steps of; receiving a user identifier; retrieving an encrypted validation record identified by the user identifier; decrypting the encrypted validation record so as to provide decrypted information; and authenticating access to data in the distributed file system using the decrypted information to provide anonymous authentication;
providing a shared access to private files system to allow users to share concatenated data maps in a shared environment without requiring any additional physical resources such as servers, discs etc. by steps of, provision of public ID, encrypted communication and identifying data with very small file;
providing a MS messenger system to allow synchronisation of system and user messages in an irrefutable manner, by allowing messaging where identity is validated to prevent spam and further uses this identity to allow digitally validated document signing and accounts are created from a very good known source of personal account information which need not be a public account and can be a private account as in a maidsafe.net account and communications are via a digital contract which is digitally signed and the conversation is subject to the contract terms;
wherein, the above combination provides a unique system with cumulative and synergistic benefits to allow people to effectively control access to their own digital resources and secure communications, store data & share resources, share private files & secure data without using servers, anonymous authentication of users, with an assurity of a self healing, fault resistant, and duplicate removal network and corporate tree network.

10. The product of claim 2 further comprising a MS messenger product that allows one to access any computer via this product and have their own data and desktop represented to them as well as the ability to communicate securely and share digital resources without involving third party access controls or dedicated servers, the product comprising the following steps:
providing a Perpetual data system to ensure there are several copies of each piece of data at several geographic locations generated by algorithms which monitor each other and create further copies on any type of failure or corruption of a single copy;
providing a self encryption system to allow the data to be chunked, renamed, byte or bit swapped, encrypted and compressed through algorithms seeded by elements derived from the data itself so that data holds the key to reversing the processes used and these are recorded for later use and aids security and duplicate removal on a network wide basis;
providing a n+p key sharing system to allow users to log in with a created base ID, the ID is validated from a supervising node—a manager, users are provided with a further key (Manager's key) to allow access by manager and the corporate structure decided upon can be viewed as a tree and accessed as such to provide access to all users' data beneath or equivalent in some cases to the current user level;
providing a data maps system to allow the creation of a database or ‘map’ of associated file chunks and their identifiers and provides a mechanism that allows data that has preferably been split into chunks, to be stored, managed and accessed in a way that guarantees its convenient and secure availability to its owner(s);
providing an anonymous authentication system to allow authentication access to a distributed system comprising the steps of; receiving a user identifier; retrieving an encrypted validation record identified by the user identifier; decrypting the encrypted validation record so as to provide decrypted information; and authenticating access to data in the distributed file system using the decrypted information to provide anonymous authentication;
providing a shared access to private files system to allow users to share concatenated data maps in a shared environment without requiring any additional physical resources such as servers, discs etc. by steps of, provision of public ID, encrypted communication and identifying data with very small file;
providing a MS messenger system to allow synchronisation of system and user messages in an irrefutable manner, by allowing messaging where identity is validated to prevent spam and further uses this identity to allow digitally validated document signing and accounts are created from a very good known source of personal account information which need not be a public account and can be a private account as in a maidsafe.net account and communications are via a digital contract which is digitally signed and the conversation is subject to the contract terms;
wherein, the above combination provides a unique system with cumulative and synergistic benefits to allow people to effectively control access to their own digital resources and secure communications, store data & share resources, share private files & secure data without using servers, anonymous authentication of users, with an assurity of a self healing, fault resistant, and duplicate removal network and corporate tree network.

11. The system of claim 1, said method further comprising of the following steps;
logging in with a created base ID;
validating the ID from a supervising node (this is a manager); and
providing a further key (manager's key) to allow access by manager.

12. The system of claim 11, wherein the corporate structure decided upon can be viewed as a tree and accessed as such, to provide access to all users' data beneath or equivalent in some cases to the current user level.

13. The system of claim 11, wherein the method further comprises providing file sharing via the implementation of the shared access to private files.

14. The system of claim 11, wherein all or some copies of data can be stored on the Internet to allow users access from any internet location, removing the requirement for VPN.

15. The system of claim 11, wherein the method further comprises providing contract conversations and an encrypted irrefutable messaging system.

16. The system of claim 11, wherein the method further comprises implementing a one time ID authentication process to ensure the safety of users and the obfuscation of particular user files and data, thereby dramatically enhancing security.

17. The system of claim 11, wherein the method further comprises implementing granular security levels comprising the following options:
all data merely backed up and local copy untouched;
all data backed up and local copy of chunks maintained (off line mode); and
all data removed from computer and only accessible from msSAN.

18. The system of claim 17 wherein the supervisor or maid ID can be replicated in an shared mechanism such as n+p key sharing, allowing a key to be split across many parties but require only a percentage to retrieve the main key.

19. A computer program product for granular accessibility to data in distributed network or corporate network that allows one to access any computer via the product and have their own data and desktop represented to them as well as the ability to access digital resources without involving a third party access controls or dedicated servers, the product comprising:
a storage medium readable by a processing circuit and storing instructions for execution by the processing circuit;
a perpetual data system, wherein the perpetual data system ensures there are several copies of each piece of data at several geographic locations generated by algorithms which monitor each other and create further copies on any type of failure or corruption of a single copy;
an anonymous authentication system, wherein the anonymous authentication system allows authentication access to a distributed system comprising the steps of: receiving a user identifier, retrieving an encrypted validation record identified by the user identifier, decrypting the encrypted validation record so as to provide decrypted information, and authenticating access to data in the distributed file system using the decrypted information to provide anonymous authentication; and
an n+p key sharing system, wherein the n+p sharing system allows users to log in with a created base ID, the ID is validated from a supervising node—a manager, users are provided with a further key (Manager's key) to allow access by manager and the corporate structure decided upon can be viewed as a tree and accessed as such to provide access to all user's data beneath or equivalent in some cases to the current user level;
wherein the computer program product provides cumulative and synergistic benefits to allow people to effectively control access to their own digital resources without using servers, anonymous authentication of users, with an assurity of a self healing, fault resistant, and duplicate removal network and corporate tree network.
